(19) United States
(12) Patent Application Publication
(10) Pub. No.: US 2023/0348338 A1
(43) Pub. Date: Nov. 2, 2023

(54) GRANULAR POLYMERIC MICRONUTRIENT COMPOSITIONS AND METHODS AND USES THEREOF

(71) Applicant: Verdesian Life Sciences U.S., LLC, Cary, NC (US)

(72) Inventors: Jason GORDON, Baltimore, MD (US); Peimin Shao, Chapel Hill, NC (US); Jake Socherman, West Linn, OR (US)

(21) Appl. No.: 18/014,395

(22) PCT Filed: Jul. 6, 2021
(86) PCT No.: PCT/US2021/040470

§ 371 Date: Jan. 4, 2023

Related U.S. Application Data
(60) Provisional application No. 63/048,772, filed on Jul. 7, 2020.

(51) Int. Cl. C05D 9/02; C05G 1/00; C05G 5/12; C05G 5/40; C05G 3/40; A01C 21/00

(52) U.S. Cl. CPC C05D 9/02; C05G 1/00; C05G 5/12; C05G 5/40; C05G 3/40; A01C 21/00

(57) ABSTRACT

The present invention relates to compositions and methods for lowering the pH of soil microenvironments so as to increase the micronutrient uptake of growing plants. The composition of the invention is in a granulated form comprising polyanionic polymers that are complexed with micronutrients such as Zn, Mn and Cu and optionally a sulfur source. Such granulated compositions are able to continuously release micronutrients on demand at a steady concentration over a certain period of time.

### FIELD OF THE INVENTION

The present invention relates to compositions and methods for lowering the pH of soil microenvironments so as to increase the micronutrient uptake of growing plants. The composition of the invention is in a granulated form comprising polyanionic polymers that are complexed with micronutrients such as Zn, Mn, Fe and Cu and optionally a sulfur source.

### BACKGROUND

In order to maintain healthy growth, plants must extract a variety of elements from the soil in which they grow. These elements include the micronutrients zinc, iron, manganese, copper, boron, cobalt, vanadium, selenium, silicon, and nickel. However, many soils lack sufficient quantities of these micronutrients or contain them only in forms, which cannot be readily taken up by plants. To counteract these deficiencies, sources of the deficient element(s) are commonly applied to soils in order to improve growth rates and yields obtained from crop plants. This application has generally been accomplished using oxides, sulfates, oxysulfates, chelates, and other formulations.

In ordinary agricultural soil, pHs vary from about 4.5 to 8.3. In fields with naturally occurring pHs in excess of 7, restricted availability of micronutrients has been observed due to the formation of insoluble reaction products (fixation). Although the availability of most micronutrients generally increases as the pH decreases, maximum crop yields are normally obtainable at higher pHs. Thus, there is a fine balance between optimal pH for micronutrient absorption and obtaining maximum crop yields.

In order to compensate for the lack of available micronutrients, many farmers often apply excess amounts of micronutrient-containing fertilizers to the soil. These applications may solve the above-mentioned problems, but at a high cost to the farmer. Thus, it would be highly desirable to develop formulations that can effectively deliver sufficient micronutrients to plants and/or crops without affecting the uptake and/or presence of macronutrients.

### SUMMARY OF THE INVENTION

One aspect of the invention is directed to a granular polymeric micronutrient composition comprising a polyanionic polymer component; and a micronutrient component, wherein the polyanionic polymer component and the micronutrient component are compressed into homogenous composite granules. In some embodiments, the granular polymeric micronutrient composition further comprises sulfur (S), wherein the sulfur, polyanionic polymer component and the micronutrient component are compressed into homogenous composite granules.

Another aspect of the invention is directed to an agricultural composition comprising the granular polymeric micronutrient composition of the invention and an agricultural product. In some embodiments, the agricultural product is a fertilizer.

Another aspect of the invention is directed to a method of fertilizing soil and/or improving plant/crop growth and/or health comprising applying a granular polymeric micronutrient composition disclosed herein or an agricultural composition as disclosed herein to the soil.

### BRIEF DESCRIPTION OF THE DRAWINGS

FIG. 1 is a line graph showing the various dissolution rates of ZnSO₄, Zn source without any polymer (MS Zn w/o polymer), Zn source with BC polymer (MS Zn w/BC), and Zn source with T5 polymer (MS Zn w/T5).

FIG. 2 is a line graph showing the various dissolution rates of ZnSO₄, Zn source without any polymer (MS Zn w/o polymer), Zn source with BC polymer (MS Zn w/BC), and Zn source with T5 polymer (MS Zn w/T5).

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Advantageously, the granular polyanionic micronutrient compositions and methods described herein have been shown to provide a controlled and steady release of micronutrients thereby improving plant growth and health. Not to be bound by theory, but it is believed that the highly negatively charged polyanionic polymer functions as an ion exchange site interacting (e.g., complexing or associating) with micronutrients and thereby protecting them from the soil environment. Otherwise, micronutrients would be exposed to soil particles that can bind to or lock up the micronutrients and/or convert the micronutrients to less available forms. Further, the polyanionic polymer provides a microenvironment of low pH in and around the micronutrients (which are in granular form) thereby increasing the availability of the micronutrients (such as zinc, iron, manganese and copper) to the plant and/or crop. In addition, the polyanionic polymer component aids in controlling the release of these micronutrients to the plant and/or crop, thereby serving as a source of on-demand supply of micronutrients to the plant and/or crop. Lastly, these beneficial properties are particularly enhanced for polyanionic micronutrient compositions in granular form as the polyanionic polymer is in close proximity to the micronutrients when compressed into a granule thereby promoting their association with each other.

Thus, the polyanionic polymer incorporated into the granular polyanionic polymer composition as disclosed herein provides longevity of the performance of the cation micronutrient as described in more detail below.

### Definitions

As used herein, the term “complex” refers to chelates, coordination complexes, and salts of micronutrients, wherein micronutrients associate with functional groups of the polyanionic polymer in a covalent (i.e., bond forming) or noncovalent (e.g., ionic, hydrogen bonding, or the like) manner. In a complex, a central moiety or ion (e.g., micronutrient) associates with a surrounding array of bound molecules or ions known as ligands or complexing agents (e.g., functional groups of the side chains present in the polyanionic polymer). The central moiety binds to or associates with several donor atoms of the ligand, wherein the donor atoms can be the same type of atom or can be a different type of atom (e.g., oxygen atom(s)). Ligands or complexing agents bound to the central moiety through several of the ligand's donor atoms forming multiple bonds (i.e., 2, 3, 4 or even 6 bonds) are referred to as polydentate ligands. Complexes with polydentate ligands are called chelates. Typically, complexes of central moieties with ligands are increasingly more soluble than the central moiety by itself because the ligand(s) that surround(s) the central moiety does not dissociate from the central moiety once in solution and solvate(s) the central moiety thereby promoting its solubility.

As used herein, the term “salt” refers to chemical compounds consisting of an assembly of cations and anions. Salts are composed of related numbers of cations (positively charged ions) and anions (negative ions) so that the product is electrically neutral (without a net charge). Many ionic compounds exhibit significant solubility in water or other polar solvents. The solubility is dependent on how well each ion interacts with the solvent. Further, salts can be classified as “partial” or “complete” salts. Partial salts refer to chemical compounds, which are not electrically neutral because they contain an uneven number of cations and anions. For example, a partial salt refers to a chemical compound (e.g., a granular polyanionic micronutrient composition) having anions (e.g., functional groups of the polyanionic polymer) that are free and are not associated with or complexed to a cation (e.g., a micronutrient). By contrast, complete salts refer to chemical compounds, which are electrically neutral because all of the anions (e.g., functional groups of the polyanionic polymer) are associated and/or complexed with a cation (e.g., micronutrient).

As used herein, the term “anionic functional group” refers to chemical functional groups that are able to form an anion when exposed to basic conditions (e.g., a pH greater than about 7). Exemplary functional groups include, but are not limited to, carboxylates, sulfonates, phosphonates, alcohols (—OH) and/or thiols (—SH).

As used herein, the term “non-ionic functional group” refers to chemical functional groups that are not anionic. In other words, non-ionic functional groups are chemical functional groups that are not able to render an anion when exposed to basic conditions (i.e., a pH greater than about 7). Exemplary functional groups include, but are not limited to, esters, amides, halogens, alkoxides, nitriles, etc.

As used herein, the term “ester” refers to a chemical compound derived from an acid (organic or inorganic) in which at least one —OH (hydroxyl) group of the acid is replaced by an −O-alkyl (alkoxy) group, such as —OCH₃, —OCH₂CH₃, etc.

As used herein, the term “amide” is an organic compound containing the group C(O)NH₂, related to ammonia by replacing a hydrogen atom by an acyl group.

As used herein, the term “thermal stability” refers to the stability of a substance when exposed to thermal stimuli over a given period of time. Examples of thermal stimuli include, but are not limited to heat generated from an electrical source and/or heat generated from the sun.

As used herein, the term “chemical stability” refers to the resistance of a substance to structurally change when exposed to an external action such as air (which can lead to oxidation), light (e.g., sunlight), moisture/humidity (from water), heat (from the sun), and/or chemical agents. Exemplary chemical agents include, but are not limited to, any organic or inorganic substance that can degrade the structural integrity of the compound of interest (e.g., the disclosed polyanionic polymer).

As used herein, the term “degradation” refers to the ability of external biological organisms to break down the structural stability of a substance (e.g., disclosed anionic polymer). Exemplary biological organisms include, but are not limited to, bacteria and microorganisms present in the soil.

As used herein, the term “micronutrient” is to be understood as nutrients essential to plant growth and health that are only needed in very small quantities. A non-limiting list of micronutrients required by plants include zinc (Zn), iron (Fe), manganese (Mn), copper (Cu), boron (B), molybdenum (Mo), and chlorine (Cl).

As used herein, the term “Size Guide Number (SGN)” refers to the diameter, expressed as millimeters×100, of the fertilizer granules based on the median (or midpoint) within the batch. It means that half of the fertilizer granules are larger than the set SGN and half are smaller. This is determined by passing the fertilizer through various sieves and using the amounts retained by each to calculate the SGN. For example, a fertilizer of SGN 250 will have 50 percent of its particles retained on or around a sieve with a 2.5-millimeter opening.

As used herein, the term “median” refers to the value where half of the particle population resides above this point, and half of the particles resides below this point and is usually reported in millimeters (mm). For a particle size distribution, the median is called the D50 of a particle.

As used herein, the term “uniformity index (UI)” refers to as a variable that expresses relative particle size variation. UI values within the range of about 40-60 indicate that the particles are uniform in size. The larger the UI value, the more uniform in particle size variation of a product. Values outside this range indicate large variability in particle size distribution. UI is the ratio of a larger (d95) to smaller (d10) granule for a specific granular composition multiplied by 100: Formula to calculate UI is =D10/D95×100, wherein D10=particle diameter (mm) corresponding to 10% passing and D95=particle diameter (mm) corresponding to 95% passing. For example, the meaning of a product with a UI of 50=average small particle (0.80 mm) is half the size of the average large particle (1.6 mm). A product with varying particle sizes and density can result in inconsistent distribution of product delivering inconsistent results.

As used herein, the term “mesh size” refers to the U.S. Mesh Size (or U.S. Sieve Size) that is defined as the number of openings in one square inch of a screen. For example, a 36 mesh screen will have 36 openings while a 150 mesh screen will have 150 openings. Since the size of screen (one square inch) is constant, the higher the mesh number the smaller the screen opening and the smaller the particle that will pass through. Generally, U.S. Mesh Size is measured using screens down to a 325 mesh (325 openings in one square inch).

Sometimes the mesh size of a product is noted with either a minus (−) or plus (+) sign. These signs indicate that the particles are either all smaller than (−) or all larger than (+) the mesh size. For example, a product identified as −100 mesh would contain only particles that passed through a 100 mesh screen. A +100 grade would contain particles that did not pass through a 100 mesh screen. When a grade of product is noted with a dash or a slash, it indicates that the product has particles contained within the two mesh sizes. For example, a 30/70 or 30-70 grade would only have particles that are smaller than 30 mesh and larger than 70 mesh.

As used herein, the term “particle density” refers to the mass to volume ratio of particles and/or granules that is reported as lbs/ft³ or kg/m³. Unlike bulk density, particle density does not include the space between individual particles but rather a measurement of the particle density itself.

As used herein, the term “moisture holding capacity” means the maximum water content held in a unit mass (a granule).

As used herein, the term “homogenous” means that a composition is uniform throughout the composition such that it is identical no matter where you sample it.

As used herein, the term “composite” refers to a mixture of two or more materials, which have dissimilar chemical or physical properties and are merged to create a material with properties unlike the individual materials. Within the finished structure, the individual materials remain separate and distinct thereby distinguishing composites from mixtures. At times, one of the materials present in the composite can make the other material stronger, i.e., micronutrients are being released more efficiently in the presence of a polyanionic polymer, thus the polyanionic polymer makes the micronutrient “stronger”.

As used herein, the term “soil” is to be understood as a natural body comprised of living (e.g., microorganisms (such as bacteria and fungi), animals and plants) and nonliving matter (e.g., minerals and organic matter (e.g., organic compounds in varying degrees of decomposition), liquid, and gases), that occurs on the land surface and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

Additional definitions may follow below.

### I. Composition

The invention relates to granular polymeric micronutrient compositions comprising a polyanionic polymer component and a micronutrient component, wherein both components are compressed into a homogenous composite granule. Each component is described in more detail below.

The amount of each component in the granular polymeric micronutrient composition can vary. For example, in some embodiments, the amount of polyanionic polymer component ranges from about 1% to 99% by weight, from about 1% to about 90% by weight, from about 10% to about 90%, from about 20% to about 90%, from about 30% to about 90%, from about 40% to about 90%, from about 50% to about 90%, from about 60% to about 90%, from about 70% to about 90%, or from about 80% to about 90% by weight based on the total weight of the granular polymeric micronutrient composition. In some embodiments, the amount of polyanionic polymer component ranges from about 2% to about 99%, from about 3% to about 90%, from about 5% to about 80% from about 7% to about 70%, from about 10% to about 60%, from about 10% to about 50%, from about 10% to about 40%, from about 12% to about 30%, from about 12% to about 25% by weight based on the total weight of the granular polymeric micronutrient composition. In some embodiments, the amount of polyanionic polymer is at least about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or at least 98% by weight based on the total weight of the granular polymeric micronutrient composition.

The amount of the micronutrient component can vary. In some embodiments, the micronutrient component is present in the granular micronutrient composition ranges from about 0.1% to about 50%, from about 0.1% to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 8%, from about 0.1% to about 5%, or from about 0.1% to about 3% by weight based on the total weight of the composition. In some embodiments, the amount of micronutrient component present in the granular micronutrient composition ranges from about 1% to about 50%, from about 5% to about 45% from about 7% to about 40%, from about 8% to about 35% from about 10% to about 30% from about 12% to about 25%, or from about 15% to about 20% by weight based on the total weight of the granular polymeric micronutrient composition.

In some embodiments, the amounts of polyanionic polymer component and micronutrient component can vary. In some embodiments, the polyanionic polymer component and micronutrient component are present in the granular polymeric micronutrient composition in a weight ratio of from about 1:1,000 to 1,000 to 1; about 1:500 to about 500:1; about 1:250 to about 250:1, about 1:200 to about 200:1, about 1:150 to about 150:1; about 1:100 to about 100:1; about 1:75 to about 75:1; about 1:50 to about 50:1; about 1:25 to about 25:1; about 1:20 to about 20:1; about 1:15 to about 15:1; about 1:10 to about 10:1; about 1:8 to about 8:1; about 1:5 to about 5:1; about 1:3 to about 3:1; or about 2:1 to about 1:2 of polyanionic polymer component to micronutrient component.

These granular polymeric micronutrient compositions are designed to promote increased performance and nutrient availability throughout the growing season, being a homogeneous micronutrient granule containing unique physical and agronomic characteristics. In particular, these granular polymeric micronutrient compositions are able to locally decrease the pH of the soil, thereby promoting the controlled and continuous release of micronutrients to nearby plants and/or crops. The granular polymeric micronutrient compositions are therefore very useful in methods of fertilizing plants and/or improving plant growth.

Furthermore, the granular formulation of the polymeric micronutrient compositions provides the polyanionic polymer and the micronutrients to be in close proximity to each other. As such the polyanionic polymer can associate with the micronutrients and can modulate the release to the micronutrients into the environment, i.e., the soil. Not to be bound by theory, but it is believed that the stronger the association is between the micronutrients and the polyanionic polymer the slower the release of the micronutrients is. The granular formation further provides modulation of the micronutrient release by being able to control the size and/or shape of the granule as well as the compactability/compressability of the granule.

Likewise, the lowering of the pH of soil microenvironments can be better controlled with polymeric micronutrient compositions in a granular formulation because granules can exert their effects locally around them, i.e., providing an acidic environment, while being stationary in the soil at the same location, whereas other formulation types such as powders and/or solutions can travel to other locations.

Lastly, granule formulations as disclosed herein provide several benefits to the user such as ease of handling, ease of carrying out field applications, ease of transportation, and/or ease of mixing the polymeric micronutrient composition with other agricultural products, e.g., fertilizer.

### A.1. Polyanionic Polymer Component

Generally speaking, the disclosed polymers should have a molecular weight of about 500-5,000,000 Da, from about 1,000-100,000 Da, from about 1,500-50,000 Da, from about 1,500 to about 10,000 Da, or from about 1,800 to about 5,000 Da and contain at least three and preferably more repeat units per molecule (preferably from about 10-500 Da). The polymers may be in partial or complete salt form. Moreover, the partial or complete salts of the polymers should be water dispersible and preferably water soluble, i.e., they should be dispersible or soluble in pure water to a level of at least about 5% w/w at room temperature with mild agitation.

Advantageously, at least about 50%, about 55%, about 60%, about 65%, about 70%, about 75%, about 80%, about 85%, about 90%, or at least about 95% (by mole) of repeat units contain at least one carboxylate group. These species also are typically capable of forming stable solutions in pure water up to at least about 5%, 10%, 15%, 20%, 25%, 30%, 35%, 40%, 45%, or at least about 50% w/w solids at room temperature.

To summarize, the preferred polymers disclosed herein have the following characteristics:
The polymers should be dispersible and more preferably fully soluble in water.
The polymers should have a significant number of anionic functional groups, preferably at least about 90 mole percent by weight, more preferably at least about 96 mole percent by weight, and most preferably the polymers are essentially free of non-anionic functional groups.
The polymers are stable thermally and chemically for convenient use.
The polymers should be essentially free of ester groups, i.e., no more than about 5 mole percent thereof, and most preferably no more than about 1 mole percent.
The polymers should have only a minimum number of amide-containing repeat units, preferably no more than about 10 mole percent thereof, and more preferably no more than about 5 mole percent.
The polymers should have only a minimum number of monocarboxylate repeat units, preferably no more than about 10 mole percent thereof, and more preferably no more than about 5 mole percent.

The ensuing detailed description of preferred polymers makes use of the art-accepted term “repeat units” to identify the repeat units in the polymers. As used herein, “repeat unit” refers to chemically converted forms (including isomers and enantiomers) of initially chemically complete monomer molecules, where such repeat units are created during polymerization reactions, with the repeat units bonding with other repeat units to form a polymer chain. Thus, a type B monomer will be converted to a type B repeat unit, and type C and type G monomers will be converted to type C and G repeat units, respectively. For example, the type B maleic acid monomer will be chemically converted owing to polymerization conditions to the corresponding type B maleic acid repeat unit, as follows:

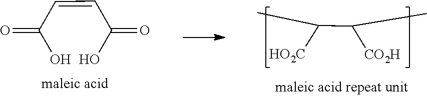

Different monomers within a given polymerization mixture are converted to corresponding repeat units, which bond to each other in various ways depending upon the nature of the repeat groups and the polymerization reaction conditions, to create the final polymer chain, apart from end groups.

In carrying out the invention, it has been determined that certain specific families or classes of polymers are particularly suitable. These are described below as “Class I,” “Class IA,” and “Class II” polymers. Of course, mixtures of these polymer classes are also contemplated.

### A.2. Class I Polymers

The Class I polyanionic polymers disclosed herein are at least tetrapolymers, i.e., they are composed of at least four different repeat units individually and independently selected from the group consisting of type B, type C, and optionally one or more type G repeat units (which can be the same or different), and mixtures thereof, described in detail below. However, the Class I polymers comprehend polymers having more than four distinct repeat units, with the excess repeat units being selected from the group consisting of type B, type C, and type G repeat units, and mixtures thereof, as well as other monomers or repeat units not being type B, C, or G repeat units.

In some embodiments, Class I polymers contain at least one repeat unit from each of the B, C, and G types, one other repeat unit selected from the group consisting of type B, type C, and type G repeat units, and optionally other repeat units not selected from type B, type C, and type G repeat units. In some embodiments, Class I polymer comprises type B repeat unit(s), type C repeat unit(s), or a combination thereof. In some embodiments, polymers comprise a single type B repeat unit, a single type C repeat unit, and two different type G repeat units, or two different type B repeat units, a single type C repeat unit, and one or more different type G repeat units.

However constituted, preferred Class I polymers contain at least about 70, 75, 80, 85, 90, 91, 92, 93, 94, 95, 96, 97, or 98 mole percent (more preferably at least about 99 mole percent) of repeat units selected from the group consisting of type B, C, and G repeat units (i.e., the polymers should contain no more than about 10 mole percent (preferably no more than about 4 mole percent) of repeat units not selected from types B, C, and G). In some embodiments, the preferred Class I polymers contains about 10 to about 90 mole percent of type B repeat units and about 90 to 10 mole percent of type C repeat units. In some embodiments, the preferred Class I polymers contains about 20 to about 80 mole percent of type B repeat units and about 80 to 20 mole percent of type C repeat units. In some embodiments, the preferred Class I polymers contains about 30 to about 70 mole percent of type B repeat units and about 70 to 30 mole percent of type C repeat units. In some embodiments, the preferred Class I polymers contains about 40 to about 60 mole percent of type B repeat units and about 60 to 40 mole percent of type C repeat units. In some embodiments, the preferred Class I polymers contain at least about 50 mole percent of type B or type C repeat unit(s).

The Class I polymers are easily converted to partial or fully saturated salts by a simple reaction with an appropriate salt-forming cation compound. Usable cations can be simple cations such as sodium, but cations that are more complex can also be used, such as cations containing a metal atom and other atom(s) as well, e.g., vanadyl cations. Among preferred metal cations are those derived from alkali, alkaline earth, and transition metals. The cations may also be amines (as used herein, “amines” refers to primary, secondary, or tertiary amines, monoamines, diamines, and triamines, as well as ammonia, ammonium ions, quaternary amines, quaternary ammonium ions, alkanolamines (e.g., ethanolamine, diethanolamine, and triethanolamine), and tetraalkylammonium species). The most preferred class of amines are alkyl amines, where the alkyl groups have from 1 to 30 carbon atoms and are of straight or branched chain configuration. Such amines should be essentially free of aromatic rings (no more than about 5 mole percent aromatic rings, and more preferably no more than about 1 mole percent thereof). A particularly suitable alkyl amine is isopropylamine. These possible secondary cations should be reacted with no more than about 10 mole percent of the repeat units of the polymer.

### A.3. Type B Repeat Units

Type B repeat units are dicarboxylate repeat units derived from monomers of maleic acid and/or anhydride, fumaric acid and/or anhydride, mesaconic acid and/or anhydride, substituted maleic acid and/or anhydride, substituted fumaric acid and/or anhydride, substituted mesaconic acid and/or anhydride, mixtures of the foregoing, and any isomers, esters, acid chlorides, and partial or complete salts of any of the foregoing. As used herein, with respect to the type B repeat units, “substituted” species refers to alkyl substituents (preferably C1-C6 straight or branched chain alkyl groups substantially free of ring structures), and halo substituents (i.e., no more than about 5 mole percent of either ring structures or halo substituents, preferably no more than about 1 mole percent of either); the substituents are normally bound to one of the carbons of a carbon-carbon double bond of the monomer(s) employed. In preferred forms, the total amount of type B repeat units in the Class I polymers should range from about 1-70 mole percent, more preferably from about 20-65 mole percent, and most preferably from about 35-55 mole percent, where the total amount of all of the repeat units in the Class I polymer is taken as 100 mole percent.

Maleic acid, methylmaleic acid, maleic anhydride, methylmaleic anhydride, and mesaconic acid (either alone or as various mixtures) are the most preferred monomers for generation of type B repeat units. Those skilled in the art will appreciate the usefulness of in situ conversion of acid anhydrides to acids in a reaction vessel just before or even during a reaction. However, it is also understood that when corresponding esters (e.g., maleic or citraconic esters) are used as monomers during the initial polymerization, this should be followed by hydrolysis (acid or base) of pendant ester groups to generate a final carboxylated polymer substantially free of ester groups.

### A.4. Type C Repeat Units

Type C repeat units are derived from monomers of itaconic acid and/or anhydride, substituted itaconic acid and/or anhydride, as well as isomers, esters, acid chlorides, and partial or complete salts of any of the foregoing. The type C repeat units are present in the preferred Class I polymers at a level of from about 1-80 mole percent, more preferably from about 15-75 mole percent, and most preferably from about 20-55 mole percent, where the total amount of all of the repeat units in the polymer is taken as 100 mole percent.

The itaconic acid monomer used to form type C repeat unit has one carboxyl group, which is not directly attached to the unsaturated carbon-carbon double bond used in the polymerization of the monomer. Hence, the preferred type C repeat unit has one carboxyl group directly bound to the polymer backbone, and another carboxyl group spaced by a carbon atom from the polymer backbone. The definitions and discussion relating to “substituted,” “salt,” and useful salt-forming cations (metals, amines, and mixtures thereof) with respect to the type C repeat unit, are the same as those set forth for the type B repeat units.

Unsubstituted itaconic acid and itaconic anhydride, either alone or in various mixtures, are the most preferred monomers for generation of type C repeat units. Again, if itaconic anhydride is used as a starting monomer, it is normally useful to convert the itaconic anhydride monomer to the acid form in a reaction vessel just before or even during the polymerization reaction. Any remaining ester groups in the polymer are normally hydrolyzed, so that the final carboxylated polymer is substantially free of ester groups.

### A.5. Type G Repeat Units

Type G repeat units are derived from substituted or unsubstituted sulfonate-bearing monomers possessing at least one carbon-carbon double bond and at least one sulfonate group, in acid, partial or complete salt, or other form, and which are substantially free of aromatic rings and amide groups (i.e., no more than about 5 mole percent of either aromatic rings or amide groups, preferably no more than about 1 mole percent of either). The type G repeat units are preferably selected from the group consisting of C1-C8 straight or branched chain alkenyl sulfonates, substituted forms thereof, and any isomers or salts of any of the foregoing; especially preferred are alkenyl sulfonates selected from the group consisting of vinyl, allyl, and methallylsulfonic acids or salts. The total amount of type G repeat units in the Class I polymers should range from about 0.1-65 mole percent, more preferably from about 1-35 mole percent, and most preferably from about 1-25 mole percent, where the total amount of all of the repeat units in the Class I polymer is taken as 100 mole percent. In some embodiments, the total amount of type G repeat units in the Class I polymers should range from about 1-20, from about 1-15, from about 1-10 or from about 1-5 mole percent, where the total amount of all of the repeat units in the Class I polymer is taken as 100 mole percent. In some embodiments, the total amount of type G repeat units in the Class I polymers should range from about 2-35, from about 4-30, from about 5-25, or from about 8-20 mole percent, where the total amount of all of the repeat units in the Class I polymer is taken as 100 mole percent. The definitions and discussion relating to “substituted,” “salt,” and useful salt-forming cations (metals, amines, and mixtures thereof) with respect to the type G repeat units are the same as those set forth for the type B repeat units.

Vinylsulfonic acid, allylsulfonic acid, and methallylsulfonic acid, either alone or in various mixtures, are deemed to be the most preferred monomers for generation of type G repeat units. It has also been found that alkali metal salts of these acids are also highly useful as monomers. In this connection, it was unexpectedly discovered that during polymerization reactions yielding the disclosed polymers, the presence of mixtures of alkali metal salts of these monomers with acid forms thereof does not inhibit completion of the polymerization reaction.

### A.6. Further Preferred Characteristics of the Class I Polymers

As noted previously, the total abundance of type B, C, and G repeat units in the Class I polymers is preferably at least about 90 mole percent, more preferably at least about 96 mole percent, and most preferably the polymers consist essentially of or are 100 mole percent B, C, and G-type repeat units. It will be understood that the relative amounts and identities of polymer repeat units can be varied, depending upon the specific properties desired in the resultant polymers. Moreover, it is preferred that the Class I polymers contain no more than about 10 mole percent of any of (I) non-carboxylate olefin repeat units, (ii) ether repeat units, (iii) ester repeat units, (iv) non-sulfonated monocarboxylic repeat units, and (v) amide-containing repeat units. “Non-carboxylate” and “non-sulfonated” refers to repeat units having essentially no carboxylate groups or sulfonate groups in the corresponding repeat units, namely less that about 55 by weight in the repeat units. Advantageously, the mole ratio of the type B and type C repeat units in combination to the type G repeat units (that is, the mole ratio of (B+C)/G) should be from about 0.5-20:1, more preferably from about 2:1-20:1, and still more preferably from about 2.5:1-10:1. Still further, the polymers should be essentially free (e.g., less than about 1 mole percent) of alkyloxylates or alkylene oxide (e.g., ethylene oxide)-containing repeat units, and most desirably entirely free thereof.

The preferred Class I polymers disclosed herein have the repeat units thereof randomly located along the polymer chain without any ordered sequence of repeat units. Thus, the polymers hereof are not, e.g., alternating with different repeat units in a defined sequence along the polymer chain.

It has also been determined that the preferred Class I polymers should have a very high percentage of the repeat units thereof bearing at least one anionic group, e.g., at least about 80 mole percent, at least about 85 mole percent, more preferably at least about 90 mole percent, and most preferably at least about 95 mole percent. It will be appreciated that the B and C repeat units have two anionic groups per repeat unit, whereas the preferred sulfonate repeat units have one anionic group per repeat unit.

For a variety of applications in accordance with the invention, certain tetrapolymer compositions are preferred, i.e., a preferred polymer backbone composition range (by mole percent, using the parent monomer names of the corresponding repeat units) is: maleic acid 35-50%; itaconic acid 20-55%; methallylsulfonic acid 1-25%; and allylsulfonic sulfonic acid 1-20%, where the total amount of all of the repeat units in the polymer is taken as 100 mole percent. It has also been found that even small amounts of repeat units, which are neither B nor C repeat units, can significantly impact the properties of the final polymers, as compared with prior BC polymers. Thus, even 1 mole percent of each of two different G repeat units can result in a tetrapolymer exhibiting drastically different behaviors, as compared with BC polymers.

The molecular weight of the polymers is also highly variable, again depending principally upon the desired properties. Generally, the molecular weight distribution for the disclosed polymers is conveniently measured by size exclusion chromatography. Broadly, the molecular weight of the polymers ranges from about 800-50,000 Da, from about 1,000-25,000 Da, from about 1,000-15,000 Da, from about 1,000-10,000 Da and more preferably from about 1,000-5,000 Da. For some applications, it is advantageous that at least 90% of the finished polymer be at or above a molecular weight of about 1,000 measured by size exclusion chromatography in 0.1 M sodium nitrate solution via refractive index detection at 35° C. using polyethylene glycol standards. Of course, other techniques for such measurement can also be employed.

In some embodiments, the Class I polymers for use in the invention are synthesized as a free acid. In some embodiments, the Class I polymers for use in the invention are synthesized as partial and/or combined salts, wherein micronutrients (e.g., Zn, Mn, and Cu) are complexed with the polyanionic polymer including the following repeat units: maleic—from about 20-55 mole percent, more preferably from about 25-50 mole percent, and most preferably from about 30-45 mole percent; itaconic—from about 35-65 mole percent, more preferably from about 40-60 mole percent, and most preferably about 50 mole percent; total sulfonated—from about 2-40 mole percent, more preferably from about 3-25 mole percent, and most preferably from about 5-20 mole percent. The total sulfonated fraction is preferably made up of a combination of methallylsulfonic and allylsulfonic repeat units, namely, methallylsulfonic—from about 1-20 mole percent, more preferably from about 3-15 mole percent, and most preferably from about 4-6 mole percent, and allylsulfonic—from about 0.1-10 mole percent, more preferably from about 0.5-8 mole percent, and most preferably from about 1-5 mole percent. These partial salts should have a pH within the range of from about 3-8, more preferably from about 4-6.5.

One preferred polymer of this type has a repeat unit molar composition of maleic 45 mole percent, itaconic 50 mole percent, methallylsulfonic 4 mole percent, and allylsulfonic 1 mole percent. This specific polymer is referred to herein as the “T5” polymer, and would be synthesized as or converted to the desired combined partial salt forms wherein the polyanionic polymer is complexed with micronutrients (e.g., Zn, Mn, and Cu).

Another type of preferred polymer is a “T-20” tetrapolymer containing about 30 mole percent maleic repeat units, about 50 mole percent itaconic repeat units, and a total of about 20 mole percent sulfonated repeat units, made up of about 15 mole percent methallylsulfonate repeat units and about 5 mole percent allylsulfonate repeat units. The T-20 polymer would be synthesized as or converted to the desired combined partial salt forms wherein the polyanionic polymer is complexed with micronutrients (e.g., Zn, Mn, and Cu).

### B. Syntheses of the Class I Polymers

Virtually any conventional method of free radical polymerization may be suitable for the synthesis of the disclosed Class I polymers. However, a preferred and novel synthesis may be used, which is applicable not only for the production of the disclosed Class I polymers, but also for the synthesis of polymers containing dicarboxylate repeat units and sulfonate repeat units and preferably containing at least one carbon-carbon double bond.

Generally speaking, the new synthesis methods comprise carrying out a free radical polymerization reaction between dicarboxylate and sulfonate repeat units in the presence of hydrogen peroxide and vanadium-containing species to achieve a conversion to polymer in excess of 90%, and more preferably in excess of 98%, by mole. That is, a dispersion of the dicarboxylate and sulfonated monomers is created and free radical initiators are added, followed by allowing the monomers to polymerize.

Preferably, the hydrogen peroxide is the sole initiator used in the reaction, but in any case, it is advantageous to conduct the reaction in the absence of any substantial quantities of other initiators (i.e., the total weight of the initiator molecules used should be about 95% by weight hydrogen peroxide, more preferably about 98% by weight, and most preferably 100% by weight thereof). Various sources of vanadium may be employed, with vanadium oxysulfates being preferred.

It has been discovered that it is most advantageous to perform these polymerization reactions in substantially aqueous dispersions (e.g., at least about 95% by weight water, more preferably at least about 98% by weight water, and most preferably 100% by weight water). The aqueous dispersions may also contain an additional monomer, but only to the minor extent noted.

It has also been found that the preferred polymerization reactions may be carried out without the use of inert atmospheres, e.g., in an ambient air environment. As is well known in the art, free radical polymerization reactions in dispersions are normally conducted in a way that excludes the significant presence of oxygen. As a result, these prior techniques involve such necessary and laborious steps as degassing, inert gas blanketing of reactor contents, monomer treatments to prevent air from being present, and the like. These prior expedients add to the cost and complexity of the polymerizations, and can present safety hazards. However, in the polymerizations of the polymers disclosed herein, no inert gas or other related steps are required, although they may be employed if desired.

One preferred embodiment comprises creating highly concentrated aqueous dispersions of solid monomer particles (including saturated dispersions containing undissolved monomers) at a temperature of from about 50-125° C., more preferably from about 75-110° C., and adding vanadium oxysulfate to give a vanadium concentration in the dispersion of from about 1-1,000 ppm, and more preferably from about 5-500 ppm (metals basis). This is followed by the addition of hydrogen peroxide over a period of from about 30 minutes to 24 hours (more preferably from about 1-5 hours) in an amount effective to achieve polymerization. This process is commonly carried out in a stirred tank reactor equipped with facilities for controlling temperature and composition, but any suitable equipment used for polymerization may be employed.

Another highly preferred and efficient embodiment involves charging a stirred tank reactor with water, followed by heating and the addition of monomers to give a dispersion having from about 40-75% w/w solids concentration. Where maleic and/or itaconic monomers are employed, they may be derived either from the corresponding acid monomers, or from in situ conversion of the anhydrides to acid in the water. Carboxylate and sulfonated monomers are preferred in their acid and/or anhydride form, although salts may be used as well. Surprisingly, it has been found that incomplete monomer dissolution is not severely detrimental to the polymerization; indeed, the initially undissolved fraction of monomers will dissolve at some time after polymerization has been initiated.

After the initial heating and introduction of monomers, the reactor contents are maintained at a temperature between about 80° C. and 125° C., with the subsequent addition of vanadium oxysulfate. Up to this point in the reaction protocol, the order of addition of materials is not critical. After introduction of vanadium oxysulfate, a hydrogen peroxide solution is added over time until substantially all of the monomers are converted to polymer. Peroxide addition may be done at a constant rate, a variable rate, and with or without pauses, at a fixed or variable temperature. The concentration of peroxide solution used is not highly critical, although the concentration on the low end should not dilute the reactor contents to the point where the reaction becomes excessively slow or impractically diluted. On the high end, the concentration should not cause difficulties in performing the polymerization safely in the equipment being used.

Preferably, the polymerization reactions of the invention are carried out to exclude substantial amounts of dissolved iron species (i.e., more than about 5% by weight of such species, and more preferably substantially less, on the order of below about 5 ppm, and most advantageously under about 1 ppm). This is distinct from certain prior techniques requiring the presence of iron-containing materials. Nonetheless, it is acceptable to carry out the polymerization in 304 or 316 stainless steel reactors. It is also preferred to exclude from the polymerization reaction any significant amounts (no more than about 5% by weight) of the sulfate salts of ammonium, amine, alkali and alkaline earth metals, as well as their precursors and related sulfur-containing salts, such as bisulfites, sulfites, and metabisulfites. It has been found that use of these sulfate-related compounds leaves a relatively high amount of sulfates and the like in the final polymers, which either must be separated or left as a product contaminant.

The high polymerization efficiencies of the preferred syntheses result from the use of water as a solvent and without the need for other solvents, elimination of other initiators (e.g., azo, hydroperoxide, persulfate, organic peroxides) iron and sulfate ingredients, the lack of recycling loops, so that substantially all of the monomers are converted to the finished polymers in a single reactor. This is further augmented by the fact that the polymers are formed first, and subsequently, if desired, partial or complete salts can be created.

### B.1. Class IA Polymers

Class IA polymers contain both carboxylate and sulfonate functional groups, but are not the tetra- and higher order polymers of Class I. For example, terpolymers of maleic, itaconic, and allylsulfonic repeat units, which are per se known in the prior art, will function as the polyanionic polymer component of the disclosed compositions. The Class IA polymers thus are normally homopolymers, copolymers, and terpolymers, advantageously including repeat units individually and independently selected from the group consisting of type B, type C, and type G repeat units, without the need for any additional repeat units. Such polymers can be synthesized in any known fashion, and can also be produced using the previously described Class I polymer synthesis.

Class IA polymers preferably have the same molecular weight ranges and the other specific parameters (e.g., pH and polymer solids loading) previously described in connection with the Class I polymers. In some embodiments, the Class IA polymers are in their free acid form. In some embodiments, the Class IA polymers are converted to the desired partial combined salts wherein the micronutrients (e.g., Zn, Mn, and Cu) are complexed with the polyanionic polymer, as described previously.

### B.2. Class II Polymers

Broadly speaking, the polyanionic polymers of this class are of the type disclosed in U.S. Pat. No. 8,043,995, which is incorporated by reference herein in its entirety. The polymers include repeat units derived from at least two different monomers individually and respectively taken from the group consisting of what have been denominated for ease of reference as B′ and C′ monomers; alternately, the polymers may be formed as homopolymers or polymers from recurring C′ monomers. The repeat units may be randomly distributed throughout the polymer chains.

In detail, repeat unit B′ is of the general formula

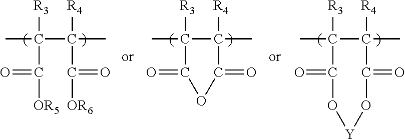

and repeat unit C′ is of the general formula

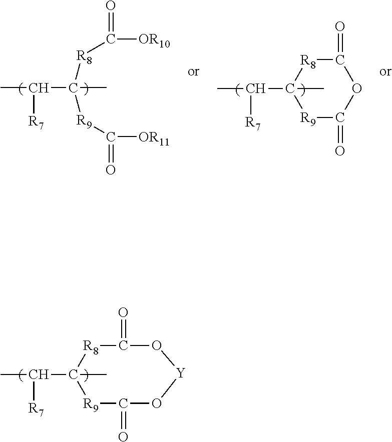

wherein each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc., up to C₃₀ based ester groups, R′CO₂ groups, OR′ groups and COOX groups, wherein R′ is selected from the group consisting of C₁-C₃₀ straight, branched chain and cyclic alkyl or aryl groups and X is selected from the group consisting of H, the alkali metals, NH₄ and the C₁-C₄ alkyl ammonium groups, R₃ and R₄ are individually and respectively selected from the group consisting of H, C₁-C₃₀ straight, branched chain and cyclic alkyl or aryl groups, R₅, R₆, R₁₀ and R₁₁ are individually and respectively selected from the group consisting of H, the alkali metals, NH₄ and the C₁-C₄ alkyl ammonium groups, Y is selected from the group consisting of Fe, Mn, Mg, Zn, Cu, Ni, Co, Mo, V, W, the alkali metals, the alkaline earth metals, polyatomic cations containing any of the foregoing (e.g., VO⁺²), amines, and mixtures thereof; and R₈ and R₉ are individually and respectively selected from the group consisting of nothing (i.e., the groups are nonexistent), CH₂, C₂H₄, and C₃H₆.

As can be appreciated, the Class II polymers typically have different types and sequences of repeat units. For example, a Class II polymer comprising B′ and C′ repeat units may include all three forms of B′ repeat units and all three forms of C′ repeat units. However, for reasons of cost and ease of synthesis, the most useful Class II polymers are made up of B′ and C′ repeat units. In the case of the Class II polymers made up principally of B′ and C′ repeat units, R₅, R₆, R₁₀, and R₁₁ are individually and respectively selected from the group consisting of H, the alkali metals, NH₄, and the C1-C4 alkyl ammonium groups. This particular Class II polymer is sometimes referred to as a butanedioic methylenesuccinic acid polymer and can include various salts and derivatives thereof.

The Class II polymers may have a wide range of repeat unit concentrations in the polymer. For example, Class II polymers having varying ratios of B′:C′ (e.g., 10:90, 60:40, 50:50 and even 0:100) are contemplated and embraced by the present invention. Such polymers would be produced by varying monomer amounts in the reaction mixture from which the final product is eventually produced and the B′ and C′ type repeat units may be arranged in the polymer backbone in random order or in an alternating pattern.

The Class II polymers may have a wide variety of molecular weights, ranging for example from 500-5,000,000 Da, depending chiefly upon the desired end use. Additionally, they can range from about 1-10,000 Da and more preferably from about 1-5,000 Da.

Preferred Class II polymers are usually synthesized using dicarboxylic acid monomers, as well as precursors and derivatives thereof. For example, polymers containing mono and dicarboxylic acid repeat units with vinyl ester repeat units and vinyl alcohol repeat units are contemplated; however, polymers principally comprised of dicarboxylic acid repeat units are preferred (e.g., at least about 85%, and more preferably at least about 93%, of the repeat units are of this character). Class II polymers may be readily complexed with salt-forming cations using conventional methods and reactants.

### B.3. Synthesis of the Class II Polymers

In general, the Class II polymers are made by free radical polymerization serving to convert selected monomers into the desired polymers with repeat units. Such polymers may be further modified to impart particular structures and/or properties. A variety of techniques can be used for generating free radicals, such as addition of peroxides, hydroperoxides, azo initiators, persulfates, percarbonates, per-acid, charge transfer complexes, irradiation (e.g., UV, electron beam, X-ray, gamma radiation and other ionizing radiation types), and combinations of these techniques. Of course, an extensive variety of methods and techniques are well known in the art of polymer chemistry for initiating free radical polymerizations. Those enumerated herein are but some of the more frequently used methods and techniques. Any suitable technique for performing free radical polymerization is likely to be useful for the purposes of practicing the present invention.

The polymerization reactions are carried out in a compatible solvent system, namely a system that does not unduly interfere with the desired polymerization, using essentially any desired monomer concentrations. A number of suitable aqueous or nonaqueous solvent systems can be employed, such as ketones, alcohols, esters, ethers, aromatic solvents, water and mixtures thereof. Water alone and the lower (C₁-C₄) ketones and alcohols are especially preferred, and these may be mixed with water if desired. In some instances, the polymerization reactions are carried out with the substantial exclusion of oxygen, and most usually under an inert gas such as nitrogen or argon. There is no particular criticality in the type of equipment used in the synthesis of the polymers, i.e., stirred tank reactors, continuous stirred tank reactors, plug flow reactors, tube reactors and any combination of the foregoing arranged in series may be employed. A wide range of suitable reaction arrangements are well known to the art of polymerization.

In general, the initial polymerization step is carried out at a temperature of from about 0° C. to about 120° C. (more preferably from about 30° C. to about 95° C. for a period of from about 0.25 hours to about 24 hours and even more preferably from about 0.25 hours to about 5 hours). Usually, the reaction is carried out with continuous stirring.

After the polymerization reaction is complete, the Class II polymers are converted to the combined partial salts of micronutrients (e.g., Zn, Mn, and Cu) at the appropriate pH levels.

### B.4. Preferred Class II Maleic-Itaconic Polymers

The most preferred Class II polymers are composed of maleic and itaconic B′ and C′ repeat units and have the generalized formula

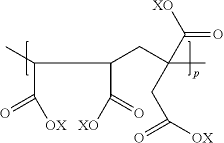

where X is either H or another salt-forming cation, depending upon the level of salt formation.

In a specific example of the synthesis of a maleic-itaconic Class II polymer, acetone (803 g), maleic anhydride (140 g), itaconic acid (185 g) and benzoyl peroxide (11 g) were stirred together under inert gas in a reactor. The reactor provided included a suitably sized cylindrical jacketed glass reactor with mechanical agitator, a contents temperature measurement device in contact with the contents of the reactor, an inert gas inlet, and a removable reflux condenser. This mixture was heated by circulating heated oil in the reactor jacket and stirred vigorously at an internal temperature of about 65-70° C. This reaction was carried out over a period of about five hours. At this point, the contents of the reaction vessel were poured into 300 g water with vigorous mixing. This gave a clear solution. The solution was subjected to distillation at reduced pressure to drive off excess solvent and water. After sufficient solvent and water have been removed, the solid product of the reaction precipitates from the concentrated solution and is recovered. The solids are subsequently dried in vacuo. A schematic representation of this reaction is shown below.

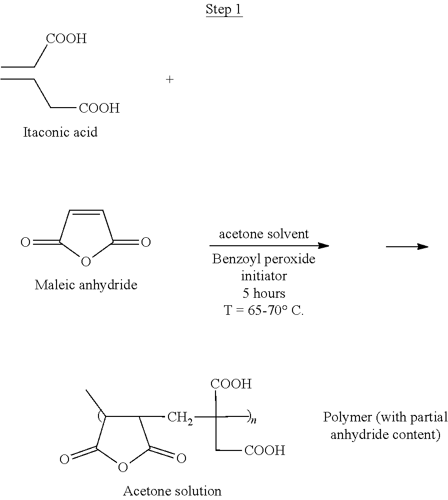

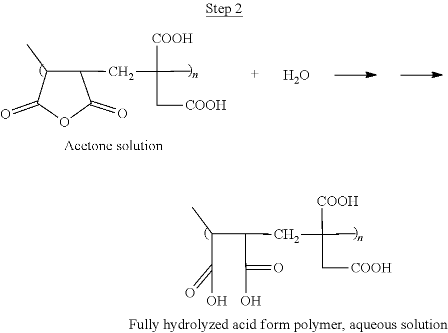 [SMILES: CC1C(=O)OC(=O)C1CC(C)(CC(=O)O)C(=O)O ; O ; CC(C(=O)O)C(CC(C)(CC(=O)O)C(=O)O)C(=O)O]

Once again, the Class II polymers should have the same preferred characteristics as those of the Class I and Class IA polymers set forth above, after conversion to the combined partial salt forms of micronutrients (e.g., Zn, Mn, and Cu).

### C. Micronutrient Component

As noted previously, the disclosed polymers are complexed to micronutrients selected from aluminum (Al), boron (B), copper (Cu), iron (Fe), manganese (Mn), molybdenum (Mo), zinc (Zn), nickel (Ni), chloride (Cl), cobalt (Co), sodium (Na), selenium (Se), silicone (Si), tungsten (W), vanadium (V) and any combination thereof. In some embodiments, the disclosed polymers are complexed with micronutrients selected from boron (B), copper (Cu), iron (Fe), manganese (Mn), molybdenum (Mo), zinc (Zn), nickel (Ni), chloride (Cl), and any combination thereof. In some embodiments, the disclosed polymers are complexed with micronutrients selected from boron (B), copper (Cu), iron (Fe), manganese (Mn), zinc (Zn), and any combination thereof. In some embodiments, the disclosed polymers are complexed with micronutrients selected from copper (Cu), iron (Fe), zinc (Zn) and a combination thereof. In some embodiments, the disclosed polymers are complexed with micronutrients selected from zinc (Zn), manganese (Mn), and boron (B). In some embodiments, the disclosed polymers are complexed with micronutrients zinc (Zn) and/or boron (B). As will be discussed in more detail below, complexation of the disclosed polymers with micronutrients primarily occur when the granule is in a soil environment, although should not be limited to such an environment.

The amount and type of micronutrient present in the granular polymeric micronutrient composition can vary. In some embodiments, the granular polymeric micronutrient composition contains zinc (Zn) in an amount ranging from about 0.1-12% by weight of Zn, from about 1-10% by weight Zn, or from about 3-10% by weight Zn based on the total weight of the granular polymeric micronutrient composition. In some embodiments, the granular polymeric micronutrient composition contains zinc (Zn) in an amount ranging from about 1-15% by weight Zn, from about 8-12% by weight Zn, from about 2-10% by weight Zn, or from about 7-10% by weight Zn based on the total weight of the granular polymeric micronutrient composition. In some embodiments, the amount of Zn present in the polymeric micronutrient composition is less than about 20%, about 19%, about 18%, about 17%, about 16%, about 15%, about 14%, about 13%, about 12%, about 11%, about 10%, about 9%, about 8%, about 7%, about 6%, about 5%, about 4%, about 3%, about 2%, or less than about 1% by weight based on the total weight of the granular polymeric micronutrient composition.

In some embodiments, the granular polymeric micronutrient composition contains manganese (Mn) in an amount ranging from about 0.1-10% by weight Mn, from about 0.1-8% by weight Mn, from about 1-8% by weight Mn, or from about 1-3% by weight Mn based on the total weight of the granular polymeric micronutrient composition. In some embodiments, these polymers can include from about 2-10% by weight Mn, from about 3-8% by weight Mn, from about 4-8% by weight Mn, or from about 4-6% by weight Mn based on the total weight of the granular polymeric micronutrient composition. In some embodiments, the amount of Mn present in the granular polymeric micronutrient composition is less than about 15%, about 14%, about 13%, about 12%, about 11%, about 10%, about 9%, about 8%, about 7%, about 6%, about 5%, about 4%, about 3%, about 2%, or less than about 1% by weight based on the total weight of the granular polymeric micronutrient composition.

In some embodiments, the granular polymeric micronutrient composition contains iron (Fe) in an amount ranging from about 0.1-12% by weight Fe, from about 1-10% by weight Fe, from about 1-7.5% by weight Fe, from about 1-5.0% by weight Fe, or from about 2-5% by weight Fe based on the total weight of the granular polymeric micronutrient composition. In some embodiments, the amount of Fe present in the granular polymeric micronutrient composition is less than about 15%, about 14%, about 13%, about 12%, about 11%, about 10%, about 9%, about 8%, about 7%, about 6%, about 5%, about 4%, about 3%, about 2%, or less than about 1% by weight based on the total weight of the granular polymeric micronutrient composition.

In some embodiments, the granular polymeric micronutrient composition contains boron (B) in an amount ranging from about 0.1-10% by weight B, from about 0.1-5% by weight B, from about 0.1-2.5% by weight B, or from about 0.1-2% by weight B based on the total weight of the granular polymeric micronutrient composition. In some embodiments, the amount of B present in the granular polymeric micronutrient composition is less than about 15%, about 14%, about 13%, about 12%, about 11%, about 10%, about 9%, about 8%, about 7%, about 6%, about 5%, about 4%, about 3%, about 2%, or less than about 1% by weight based on the total weight of the granular polymeric micronutrient composition.

In some embodiments, the granular polymeric micronutrient composition contains copper (Cu) in an amount ranging from about 0.1-10% by weight Cu, from about 0.1-8% by weight Cu, or from about 0.1-5% by weight Cu based on the total weight of the granular polymeric micronutrient composition. In some embodiments, the amount of Cu present in the granular polymeric micronutrient composition ranges from about 0.1-4% by weight Cu, from about 0.1-3% by weight Cu, or from about 0.1-2% by weight Cu based on the total weight of the granular polymeric micronutrient composition. In some embodiments, the amount of Cu present in the granular polymeric micronutrient composition is less than about 5%, about 4.5%, about 4%, about 3.5%, about 3.0%, about 2.5%, about 2%, about 1.5%, about 1.2%, about 1%, about 0.8%, about 0.6%, about 0.4%, about 0.2%, or less than about 0.1% by weight based on the total weight of the granular polymeric micronutrient composition.

All of the foregoing ranges are based upon the weight percentages of Zn, Mn, Fe, B and Cu as the corresponding micronutrient metals per se, and not in terms of compounds containing the micronutrients. Further, all of the above foregoing micronutrients can be present in any combination in the amounts as described above. Na is also preferably present in the polymers, derived from sodium hydroxide, at variable levels depending upon the pH of the product.

In some embodiments, Zn, Mn, Fe, B, Cu and any combination thereof are the only micronutrients and/or macronutrients present in the granular polymeric micronutrient composition. In some embodiments, Zn, Mn, Fe, Cu and any combination thereof are the only metals present in the granular polymeric micronutrient composition. In some embodiments, Zn, Mn, Fe, B, Cu and any combination thereof are the only agents present in the granular polymeric micronutrient composition, which promote plant growth, plant health, or a combination thereof.

In some embodiments, the disclosed compositions comprise/consist essentially of/consist of one or more micronutrients selected from Zn, Mn, Cu, Fe, and B, wherein Cu can be present in an amount ranging from about 0.1-5% by weight Cu, Fe can be present in an amount ranging from about 1-5% by weight Fe, Mn can be present in an amount ranging from about 4-8% by weight Mn, B can be present in an amount ranging from about 0.1-2%, and Zn can present in an amount ranging from about 3-10% by weight Zn based on the total weight of the granular polymeric micronutrient composition. In some embodiments, the disclosed compositions comprise/consist essentially of/consist of Zn, Mn, and B, wherein Mn is present in an amount ranging from about 4-8% by weight Mn, Zn is present in an amount ranging from about 3-10% by weight Zn, and B is present in an amount ranging from about 0.1-2% by weight B, based on the total weight of the granular polymeric micronutrient composition. In some embodiments, the disclosed compositions comprise/consist essentially of/consist of Zn and B, wherein Zn is present in an amount ranging from about 3-10% by weight Zn and B is present in an amount ranging from about 0.1-2% by weight B, based on the total weight of the granular polymeric micronutrient composition. In some embodiments, the disclosed compositions comprise/consist essentially of/consist of one or more micronutrients selected from Zn and Fe, wherein Fe is present in an amount ranging from about 1-5% by weight Fe and Zn is present in an amount ranging from about 3-10% by weight Zn based on the total weight of the granular polymeric micronutrient composition.

The micronutrients disclosed herein are complexed with the disclosed polyanionic polymers. In particular, it is believed that the micronutrients are complexed with the anionic functional groups that are present in the side chains of the disclosed anionic polymers. It is further believed that such complexation occurs only after the granular micronutrient composition has been applied to the soil. Prior to application, it is believed that the micronutrients and polyanionic polymers are considered separate components present in the granular micronutrient composition, which do not interact and/or associate with one another. Examples of anionic functional groups that are able to complex with the micronutrients once applied to the soil include but are not limited to carboxylates (present in type B and/or C repeat units), sulfonates (present in type G repeat units), and a combination thereof. In some embodiments, the micronutrients are complexed with a fraction of the anionic functional groups present in the polyanionic polymer component, thereby forming a partial salt form of the polyanionic polymer. For example, in some embodiments, the micronutrient(s) complexes with at least 1, 5, 10, 15, 20, 25, 30, 35, 40, 45, 50, 55, 60, 65, 70, 75, 80, 85, 90, or at least 95% but no more than 99% of the anionic functional groups present in the polyanionic polymer component. Partial salts of polyanionic polymers that are complexed with more than one type of micronutrient are called combined partial salts.

In some embodiments, the micronutrients are complexed with all of the anionic functional groups present in the polyanionic polymer component, thereby forming a complete salt form of the polyanionic polymer. Complete salt forms of the polyanionic polymer that are complexed with more than one type of micronutrient are referred to as combined complete salts.

In some embodiments, the granular polymeric micronutrient composition further comprises sulfur and/or calcium (Ca). Sulfur and calcium are both essential plant nutrients and are vital for the growth and development of all crops. In fact, sulfur (S), along with calcium (Ca) and magnesium (Mg), are all considered vital secondary nutrients required by plants for normal, healthy growth. Examples of sulfur sources from which sulfur present in the granular polymeric composition can be derived from include, but are not limited to, ammonium sulfate, Calcium sulfate (gypsum), elemental sulfur, or a combination thereof. The amount of sulfur and/or sulfur source present in the granular polymeric micronutrient composition can vary. For example, in some embodiments, the amount of sulfur present in the disclosed granular polymeric micronutrient composition ranges from about 0.1-15% by weight, from about 5-15% by weight, from about 8-12% by weight, from about 3-12% by weight, or from about 4-8% by weight based on the total weight of the granular polymeric micronutrient composition. In some embodiments, the amount of sulfur present in the disclosed granular polymeric micronutrient composition ranges from about 5-12% by weight, 7-12% by weight, or from about 9-12% by weight based on the total weight of the granular polymeric micronutrient composition. In some embodiments, the amount of sulfur present in the disclosed granular polymeric micronutrient composition is less than about 15%, about 14%, about 13%, about 12%, about 11%, about 10%, about 9%, about 8%, about 7%, about 6%, about 5%, about 4%, about 3%, about 2% by weight based on the total weight of the granular polymeric micronutrient composition.

Examples of calcium sources from which calcium can be derived from include, but are not limited to calcitic lime, dolomitic lime, and/or gypsum. The amount of calcium and/or calcium source present in the granular polymeric micronutrient composition can vary. For example, in some embodiments, the amount of calcium present in the disclosed granular polymeric micronutrient composition ranges from about 0.1-15% by weight, from about 5-15% by weight, from about 8-12% by weight, from about 3-12% by weight, or from about 4-8% by weight based on the total weight of the granular polymeric micronutrient composition. In some embodiments, the amount of calcium present in the disclosed granular polymeric micronutrient composition ranges from about 5-12% by weight, 7-12% by weight, or from about 9-12% by weight based on the total weight of the granular polymeric micronutrient composition. In some embodiments, the amount of calcium present in the disclosed granular polymeric micronutrient composition is less than about 15%, about 14%, about 13%, about 12%, about 11%, about 10%, about 9%, about 8%, about 7%, about 6%, about 5%, about 4%, about 3%, about 2% by weight based on the total weight of the granular polymeric micronutrient composition.

In some embodiments, the granular micronutrient compositions comprise sulfur (S) and/or Calcium (Ca) in combination with one or more micronutrients. In some embodiments, such micronutrients are selected from Cu, Fe, Mn, B and Zn. In particular embodiments, micronutrients Cu is present in an amount ranging from about 0.1%-5% by weight Cu, Fe is present in an amount ranging from about 0.1-5% by weight Fe, Mn is present in an amount ranging from about 4-8% by weight Mn, B is present in an amount from about 0.1-2%, and Zn is present in an amount ranging from about 5-12% by weight Zn based on the total weight of the granular polymeric micronutrient composition. In such embodiments, sulfur (S) is present in an amount ranging from about 5-12% by weight S and/or Calcium (Ca) is present in an amount ranging from about 5-12% by weight Ca based on the total weight of the granular polymeric micronutrient composition.

In another particular embodiment, the granular micronutrient composition comprises/consists essentially of/consists of S, Ca, Zn, Mn, Cu, Fe, and B. In such embodiments, S is present in an amount ranging from about 5-12% by weight S, Ca is present in an amount ranging from about 5-12% by weight Ca, Zn is present in an amount ranging from about 3-10% by weight Zn, Mn is present in an amount ranging from about 4-8% by weight Mn, Cu is present in an amount ranging from about 0.1-5% by weight Cu, Fe is present in an amount ranging from about 1-5% weight Fe, and B is present in an amount ranging from about 0.1-2% by weight B based on the total weight of the granular polymeric micronutrient composition.

In another particular embodiment, the granular micronutrient composition comprises/15 consists essentially of/consists S, Ca, Zn, Mn, and B. In such embodiments, S is present in an amount ranging from about 5-12% by weight S, Ca is present in an amount ranging from about 5-12% by weight Ca, Zn is present in an amount ranging from about 3-10% by weight Zn, Mn is present in an amount ranging from about 4-8% by weight Mn, and B is present in an amount ranging from about 0.1-2% by weight B based on the total weight of the granular polymeric micronutrient composition.

In another particular embodiment, the granular micronutrient composition comprises/consists essentially of/consists S, Ca, Zn, and B. In such embodiments, S is present in an amount ranging from about 5-12% by weight S, Ca is present in an amount ranging from about 5-12% by weight Ca, Zn is present in an amount ranging from about 3-10% by weight Zn, and B is present in an amount ranging from about 0.1-2% by weight B based on the total weight of the granular polymeric micronutrient composition.

In another particular embodiment, the granular micronutrient composition comprises/consists essentially of/consists S, Zn, and Fe. In such embodiments, S is present in an amount ranging from about 5-12% by weight S, Zn is present in an amount ranging from about 3-10% by weight Zn, and Fe is present in an amount ranging from about 1-5% weight Fe based on the total weight of the granular polymeric micronutrient composition.

In some embodiments, the granular micronutrient composition further comprises one or more macronutrients selected from nitrogen (N), phosphorus (P), potassium (K), magnesium (Mg), and a combination thereof. In some embodiment, sulfur and calcium are the only macronutrients present in the granular micronutrient composition.

In some embodiments, Zn, Mn, Fe, B, Cu, Ca, S and any combination thereof are the only agents present in the granular polymeric micronutrient composition, which promote plant growth, plant health, or a combination thereof.

Granular polymeric micronutrient compositions having different concentrations of micronutrients may be used in practicing the invention. For example, a granular polymeric micronutrient composition may be provided which is designated for application at a rate of about 5-40 lbs/acre, 5-10 lbs/acre, 10-20 lbs/acre, or 25-30 lbs/acre. For a granular polymeric micronutrient composition for application at higher rates higher amounts of each individual micronutrients would be required. The latter more concentrated compositions would also be designed for mixing with other plant protection products (e.g., NPK fertilizers).

### II. Granular Composition

As noted previously, the polymeric micronutrient composition disclosed herein is in the form of granules. As used herein the term “granule” refers to a small compact particle made up of numerous smaller particles (e.g., micronutrient(s)). In some embodiments, the granular polymeric micronutrient composition is a homogenous composite granule, wherein the micronutrient component and the polyanionic polymer component are compressed together as a homogenous mixture of solid material. The physical parameters of the disclosed granules/homogenous composite granules can vary. Some of these physical parameters are discussed in more detail below but should not be limited thereto.

In some embodiments, the shape of the granule is round (e.g., spherical or egg-shaped) but should not be limited thereto. Additional shapes include cubic, rectangular and/or irregular.

In some embodiments, the granular polymeric micronutrient composition contains granules having an average mesh size ranging from about 1 to about 100 (e.g., 1/100), from 6 to about 100 (e.g., 6/100), from about 10 to about 100 (e.g., 10/100), or from about 16 to about 100 (e.g., 16/100) US mesh. In other embodiments, the granular polymeric micronutrient composition contains granules having an average mesh size ranging from about 4 to about 30 (e.g., 4/30), from about 5 to about 24 (e.g., 5/24), or from about 6 to about 16 (e.g., 6/16) US mesh.

In some embodiments, the median particle size (d50) of the granules of the polymeric micronutrient composition ranges from about 0.1 to 3.5 mm, from about 0.1 to about 3 mm, from about 0.5 to about 3 mm, from about 0.5 to about 2.5 mm, from about 0.75 to about 2 mm, from about 0.75 to about 1.5, from about 0.8 to about 1.2 mm, or from about 0.9 to about 1 mm (or at least about 0.1, 0.2, 0.3, 0.4, 0.5, 0.6, 0.7, 0.8, 0.9, 1.0, 1.5, 2.0, 2.1, 2.2, 2.3, 2.4, 2.5, 2.6, 2.7, 2.8, 2.9, 3.0, 3.1, 3.2 or at least about 3.3 mm, with an upper limit of 3.5 mm). In some embodiments, the median particle size (d50) of the granules of the polymeric micronutrient composition is less than about 3.5 mm, about 3.25 mm, about 3.0 mm, about 2.75 mm, about 2.5 mm, about 2.25 mm, about 2.0 mm, about 1.75 mm, about 1.5 mm, about 1.25 mm, about 1.0 mm, about 0.75, or less than about 0.5 mm.

In some embodiments, the granular polymeric micronutrient composition contains granules having a particle size ranging from about 10 to about 500, from about 50 to about 450, from about 75 to about 400, from about 80 to about 250, or from about 90 to about 230 Size Guide Number (SGN). In some embodiments, the granules have a particle size of at least about 10 SGN, about 50 SGN, about 75 SGN, about 100 SGN, about 125 SGN, about 150 SGN, about 175 SGN, about 200 SGN, about 250 SGN, about 275 SGN, about 300 SGN, about 325 SGN, about 350 SGN, about 375 SGN, about 400 SGN, about 425 SGN, about 450, or at least about 475 SGN.

In some embodiments, the granular polymeric micronutrient composition contains granules having a uniformity index (UI) ranging between about 30-40, 30-50, 35-45, 40-60, 40-50, or 50-60 (indicating that the granules are uniform in size). In some embodiments, the UI is at least about 20, about 30, about 40, about 50, or at least about 55.

In some embodiments, the granular polymeric micronutrient composition contains granules having a particle density ranging from about 10-150 lbs/ft³, 30-100 lbs/ft³, from about 45-85 lbs/ft³, or from about 45-60 lbs/ft³.

In some embodiments, the granular polymeric micronutrient composition has a bulk density of from about 10-150 lbs/ft³, 30-100 lbs/ft³, from about 45-75 lbs/ft³, from about 50-70 lbs/ft³ or from about 60-70 lbs/ft³. In some embodiments, the bulk density is a “loose” bulk density.

In some embodiments, the granular micronutrient composition contains granules having a moisture holding capacity ranging from about 0.1 wt. % to about 10 wt. %, from about 0.5 wt. % to about 8 wt. %, from about 1 wt. % to about 7.5 wt. %, from about 1.5 wt. % to about 7 wt. %, from about 2.3 wt % to about 6.5 wt %, including exemplary values of 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4 wt %, 4.1 wt %, 4.2 wt %, 4.3 wt %, 4.4 wt %, 4.5 wt %, 4.6 wt %, 4.7 wt %, 4.8 wt %, 4.9 wt %, 5 wt %, 5.1 wt %, 5.2 wt %, 5.3 wt %, 5.4 wt %, 5.5 wt %, 5.6 wt %, 5.7 wt %, 5.8 wt %, 5.9 wt %, 6 wt %, 6.1 wt %, 6.2 wt %, 6.3 wt %, and 6.4 wt %.

The polymeric micronutrient composition provides direct contact between the various components of the granules (e.g., micronutrients, polyanionic polymer and optionally a sulfur source) to afford a homogenous granule, wherein all the components are mixed together. These granules afford a unique and localized acid microenvironment due to the presence of the polyanionic polymer, which in turn increases the availability of the micronutrients to the plants/crops. It is important for these granules to be homogenous meaning that the micronutrients and polyanionic polymer are mixed in a manner that allows for the entire amount of micronutrients to be in contact with the same amount of polyanionic polymers. Only then can the polyanionic polymer exert its beneficial interactions on the micronutrients, e.g., forming complexes with the micronutrients that protects them from exposure to various soil bacteria, etc. Furthermore, homogenous granules containing the same amount of polyanionic polymer throughout the granule provides better localized acid microenvironments around the granule compared to granules where the amount of polyanionic polymer differs within various regions of the granule resulting in varying areas of acidity around the granule. The degree of homogeneity of a single granule or a population of granules is expressed using a coefficient of variation (CV), which a skilled artisan in the field would be aware of and able to measure and calculate. The CV is also known as the relative standard devition (RSD) and represents a standardized mean of dispersion of a probability distribution and is defined by the ratio of standard deviation to the mean μ,

CV (%)=(σ/μ)×100

If the CV % is low the granule is more homogenous, whereas if the CV % is high then the granule is less homogenous.

In some embodiments the granule exhibits a coefficient of variation (CV %) that is at least about 10%, 20%, 30%, 40%, 50%, 60%, 70%, 80%, 90%, 95%, or at least bout 98%. In some embodiment the coefficient of variation ranges from about 10% to about 99%, from about 20% to about 98%, from about 30% to about 95%, from about 40% to about 90%, from about 50% to about 80%, or from about 60% to about 70%.

As we mentioned above, when applied to the soil, the resulting microenvironment will have a pH distinct (i.e., acidic) from the pH of the bulk soil surrounding the microenvironment. As the plant roots randomly grow throughout the soil, they will encounter these (acidic) microenvironments, allowing access to the readily available micronutrients while simultaneously permitting the roots to absorb other nutrients (such as nitrogen or phosphorous) from the non-acidified bulk soil surrounding the microenvironment.

When the granular polymeric micronutrient composition is applied to the soil, the resulting microenvironments should have a soil pH of from about 3-7, preferably from about 4-6, and more preferably from about 5-6. The pH of the microenvironment should remain acidic (i.e., pH of less than 7) for at least about 30 days, preferably at least about 60 days, and more preferably for from about 90-120 days after the granular polymeric micronutrient composition has been contacted with the soil. The granular polymeric micronutrient composition can be randomly distributed throughout the soil (as are the roots of the growing plants), as long as sufficient low pH microenvironments are readily available for the plant/crop to access.

As already mentioned above, the polyanionic polymer complexed with the micronutrient in the disclosed polymeric micronutrient composition (e.g. being in a soil environment) provides for a steady and continuous release of the complexed micronutrients to the plant and/or crop. In some embodiments, such continuous release of micronutrients occurs over a time period of about 1 to 90 days, about 1 to 60 days, about 1 to 30 days, about 1 to 20 days, about 1 to 10 days, about 30 to 90 days, or about 30 to 60 days (or at least 1 day or more, 5 days or more, 10 days or more, 20 days or more, or 30 days or more). In some embodiments, such continuous release of micronutrients occurs over a time period of at least 30 days, 60, days, 90 days, 120 days, 150 days, 180 days, 210 days, 240 days, or at least 270 days. In some embodiments, such continuous release of micronutrients occurs over a time period of up to 12 months.

The amount of micronutrients released during a particular time period can vary and, as a skilled artisan would recognize, depends on the type of micronutrient, the type of crop and/or plant, climate, and/or type of soil and many other factors. A skilled artisan would recognize that the rate of nutrient/active ingredient delivery generally relies on the particle size. For instance, the larger the particle size, the longer the product will take to break down, with powders offering fastest nutrient delivery (though they also often become windblown). It's important to note that particle size is not singularly responsible for the rate of breakdown; many other factors come into play as well. Particle size can also influence the rate at which a fertilizer dissolves.

In some embodiments, the amount of micronutrients released on a daily basis ranges from about 1 ppm to about 500 ppm. In some embodiments, the amount of micronutrients released on an hourly basis during a 24-hour time period ranges from about 1 to about 150 ppm, from about 1 to about 120 ppm, from about 5 to about 120 ppm, from about 10 to about 120 ppm, from about 25 to about 120 ppm, from about 50 to about 120 ppm, from about 60 to about 100 ppm from about 70 to about 90 ppm, or from about 1 to about 50 ppm, from about 5 to about 25 ppm, from about 8 to about 20 ppm, or from about 10 to about 15 ppm.

The granular polymeric micronutrient compositions having different concentrations of micronutrients may be used in practicing the invention. For example, a granular polymeric micronutrient composition may be provided which is designated for application at a rate of about 5-20 lbs/acre, 5-10 lbs/acre, 10-15 lbs/acre, 25-30 lbs/acre, or 25-50 lbs/acre. For a granular polymeric micronutrient composition for application at higher rates higher amounts of each individual micronutrients would be required. The latter more concentrated compositions would also be designed for mixing with other plant protection products.

As already mentioned above, the polyanionic polymer complexed to the micronutrient increases the chemical stability and/or thermal stability of the micronutrient when exposed to external chemical agents (organic and/or inorganic in nature) as well as conditions such as heat, moisture, air oxidation, and/or light which can affect the chemical and/or structural integrity of the micronutrient. Thus, in some embodiments, the polymeric micronutrient composition exhibits an increase in chemical stability by at least about 10%, about 20%, about 30%, about 40%, about 50%, about 60%, about 70% about 80%, about 90% or about 95%, compared to granular compositions wherein the micronutrients are not complexed with the disclosed polyanionic polymer components. In some embodiments, the polymeric micronutrient compositions exhibits an increase chemical stability ranging from about 10% to about 95%, from about 15% to about 90%, from about 20% to about 80%, from about 25% to about 70% from about 30% to about 60%, or from about 35% to about 55%, compared to granular compositions wherein the micronutrient if not complexed with the disclosed polyanionic polymer components. In some embodiments, the polymeric micronutrient composition exhibits an increase in thermal stability by at least about 10%, about 20%, about 30%, about 40%, about 50%, about 60%, about 70% about 80%, about 90% or about 95%, compared to granular compositions wherein the micronutrients are not complexed with the disclosed polyanionic polymer components. In some embodiments, the polymeric micronutrient compositions exhibits an increase chemical stability ranging from about 10% to about 95%, from about 15% to about 90%, from about 20% to about 80%, from about 25% to about 70% from about 30% to about 60%, or from about 35% to about 55%, compared to granular compositions wherein the micronutrient if not complexed with the disclosed polyanionic polymer components.

In addition to the observed increased chemical stability and/or thermal stability, the polymeric micronutrient composition also exhibits a decrease in the degradation of the micronutrients, which is often observed. Degradation of the micronutrients can occur in the soil upon exposure to biological organisms, such as soil bacteria. Thus, in some embodiments, the degradation of the micronutrient is decreased by at least about 10%, about 20%, about 30%, about 40%, about 50%, about 60%, about 70% about 80%, about 90% or about 95%, when complexed to the disclosed polyanionic polymer compared to granular compositions wherein the micronutrients are not complexed with the disclosed polyanionic polymer components. In some embodiments, the degradation of the micronutrient is decreased by about 10% to about 95%, by about 20% to about 85%, by about 30% to about 75%, by about 40% to about 65%, or by about 50% to about 65%, when complexed to the disclosed polyanionic polymer compared to granular compositions wherein the micronutrients are not complexed with the disclosed polyanionic polymer components.

Granulation of the polymeric micronutrient composition can be carried out using any known granulation method in the art. In some embodiments, granulation of the polymeric micronutrient composition can be achieved using dry granulation methods such as compaction granulation methods. During this physical process, finely divided nutrient particles are homogenized into composite granules without compromising the chemical stability and/or structural integrity of the micronutrients used. This enables the product to be handled, blended and spread in the farmer's field in a uniform manner, while maintaining its unique chemical attributes. Once the granule comes into contact with soil moisture it begins over time to revert back to the finely divided nutrient particles that it began with (particles break down and disperse) to allow for greater contact with the soil and more coverage and/or availability of the broken down and dispersed particles to the root zone of the plants/crops. In some embodiments, granulation of the polymeric micronutrient composition can be achieved via pan granulation, drum granulation, extrusion, palletization, granular crumble but should not be limited thereto.

The plants and/or crops include plants such as cereals, fruit trees, fruit bushes, grains, legumes and combinations thereof. Exemplary crops include, but are not limited to, rye, oats, maize, rice, sorghum, triticale, oilseed rape, rice, soybeans, sugar beet, sugar cane, turf, fruit trees, palm trees, coconut trees or other nuts, grapes, fruit bushes, fruit plants; beet, fodder beet, pomes, stone fruit, apples, pears, plums, peaches, almonds, cherries, and berries, for example strawberries, raspberries and blackberries; leguminous plants such as beans, lentils, peas, soybeans, peanuts; oil plants, for example rape, mustard, sunflowers; cucurbitaceae, for example marrows, cucumbers, melons; fibre plants, for example cotton, flax, hemp, jute; citrus fruit, for example oranges, lemons, grapefruit and mandarins; vegetables, for example spinach, lettuce, asparagus, cabbages, carrots, onions, tomatoes, potatoes, sweet potatoes, yams, paprika; as well as ornamentals, such as flowers, shrubs, broad leaved trees and evergreens, for example conifers, cereals, wheat, barley, oats, winter wheat, spring wheat, winter barley, spring barley, triticale, cereal rye, winter durum wheat, spring durum wheat, winter oat, spring oat, fodder cereals, ray-grass, cocksfoot, fescue, timothy, grass for seed and grassland and any combination thereof.

### III. Agricultural Composition

Any of the described granular micronutrient compositions can be combined with one or more agricultural products to render a blended agricultural composition. Exemplary agricultural products include fertilizers or other agriculturally active compounds (e.g., pesticides, herbicides, insecticides, fungicides, miticides, and combinations thereof in solid form (e.g., granules and/or prills) and/or soil amendments (e.g., limestone, dolomite, azomite, humic acid, leonardite).

In some embodiments, the described granular polymeric micronutrient composition may be mixed with a fertilizer product. In some embodiments, the granular polymeric micronutrient composition further comprises a sulfur source. In some embodiments, in such combined fertilizer/granular polymeric micronutrient compositions, the fertilizer is in the form of particles having an average diameter of from about powder size (less than about 0.001 cm) to about 10 mm, more preferably from about 0.1 mm to about 5 mm, and still more preferably from about 0.9 mm to about 3 mm. In some embodiments, the ratio of granular polymeric composition to fertilizer product ranges from about 1:1,000 to about 1,000:1, or from about 1:200 to about 200:1, or from about 1:50 to about 50:1, or from about 1:10 to about 10:1, or from about 1:5 to about 5:1, or is 1:1. In the case of the combined fertilizer/granular polymeric micronutrient composition products, the combined product can be applied at a level so that the amount of granular polymeric micronutrient composition applied is about 10-150 g per acre of soil, about 10-100 g per acre, about 10-75 g per acre, about 10-50 g per acre, or about 10-40 g per acre of soil.

The fertilizer can be a solid fertilizer, such as, but not limited to, a granular fertilizer, and the granular micronutrient composition can be mixed with the granular fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum materials. In some embodiments, the fertilizer comprises plant-available nitrogen, phosphorous, potassium, sulfur, calcium, magnesium, micronutrients or a combination thereof. In some embodiments, the fertilizer comprises a combination of plant-available nitrogen, phosphorous, potassium (e.g., N—P—K fertilizer). In some embodiments, the fertilizer comprises gypsum, Kieserite Group member, potassium product, potassium magnesium sulfate, elemental sulfur, or potassium magnesium sulfate.

In some embodiments, the granular polymeric micronutrient composition is combined with any suitable dry fertilizer for application to fields and/or crops. The described granular polymeric micronutrient composition can be applied with the application of a fertilizer. The polymeric granular micronutrient composition can be applied prior to, subsequent to, or simultaneously with the application of fertilizers. In embodiments wherein the granular polymeric micronutrient composition is applied by itself (e.g., prior to or subsequent to the application of the fertilizer), the amount of granular polymeric micronutrient composition is applied at a rate of about 10-30 lbs per acre of soil, about 10-20 lbs per acre, or about 5-40 g per acre of soil. In some embodiments, the amount of granular polymeric micronutrient composition is applied at a rate of about 25-30 lbs per acre.

The granular polymeric micronutrient composition or granular polymeric micronutrient composition/fertilizer compositions can be applied in any manner, which will benefit the crop of interest. In some embodiments, these compositions are applied to the soil via broadcast applications, banded applications, sidedress application, with-the-seed application, or any combination of these application methods. In some embodiments, these compositions are applied to growth mediums in a band or row application. In some embodiments, the compositions are applied to or throughout the growth medium prior to seeding or transplanting the desired crop plant. In some embodiments, the compositions can be applied to the root zone of growing plants.

### IV. Method Section

In some embodiments, the granular polymeric micronutrient composition is used directly. In other embodiments, the granular polymeric micronutrient composition is formulated in ways to make its use convenient in the context of productive agriculture. The granular polymeric micronutrient composition used in these methods includes the polyanionic polymers complexed with micronutrients as described above. These granular polymeric micronutrient compositions can be used in methods for improving plant growth comprising applying a granular polymeric micronutrient composition as disclosed herein with soil. In some embodiments, the granular polymeric micronutrient composition is applied to the soil prior to emergence of a planted crop. In some embodiments, the granular polymeric micronutrient composition is applied to the soil adjacent to the plant and/or at the base of the plant and/or in the root zone of the plant. The type of plant can vary. Exemplary plants include, but are not limited to, cereal, wheat, barley, oat, triticale, rye, rice, maze, soya, beans, potato, vegetable, peanuts, cotton, oilseed grape, and fruit plant.

Methods for improving plant health can also be achieved by applying a granular polymeric micronutrient composition as disclosed herein with soil. Correction of multiple deficiencies, as determined by tissue analysis and soil testing, of any agricultural or horticultural crop can be achieved. Particularly, agricultural or horticultural crop where a deficiency of iron and/or zinc has been determined. Depending on the type and severity of the micronutrient deficiency, the granular polymeric micronutrient composition is applied at various field rates and amounts. In some embodiments, the granular polymeric micronutrient composition is applied at a field rate of about 5-10 lbs/acre for mild, about 15 lbs/acre for moderate, and/or about 25-30 lbs/acre for severe deficiencies. In some embodiments, the granular micronutrient composition is used in an amount from about 25 to about 300 kg/ha, from about 25 to about 250 kg/ha, or from about 100 to about 200 kg/ha.

Particular embodiments of the subject matter described herein include:

1. A granular polymeric micronutrient composition comprising:
a polyanionic polymer component; and
a micronutrient component,
wherein the polyanionic polymer component and the micronutrient component are compressed into homogenous composite granules.

2. The granular polymeric micronutrient composition of embodiment 1, wherein the homogenous composite granules have a mesh size ranging from about 16 to about 100 US mesh.

3. A granular polymeric micronutrient composition comprising:
a polyanionic polymer component; and
a micronutrient component selected from zinc (Zn), manganese (Mn), iron (Fe), copper (Cu), boron (B), and a combination thereof,
wherein the polyanionic polymer component and the micronutrient component are compressed into homogenous composite granules having a mesh size ranging from about 16 to about 100 US mesh.

4. The granular polymeric micronutrient composition of any above embodiment, wherein the homogenous composite granules have a mesh size ranging from about 6 to about 16 US mesh.

5. The granular polymeric micronutrient composition of any above embodiment, wherein the homogenous composite granules have a mean particle size (d50) ranging from about 0.5 to about 2.5 mm.

6. The granular polymeric micronutrient composition of any above embodiment, wherein the homogenous composite granules have a particle size ranging from about 90 to about 230 SGN.

7. The granular polymeric micronutrient composition of any above embodiment, wherein the homogenous composite granules have a uniformity index ranging between 35-45.

8. The granular polymeric micronutrient composition of any above embodiment, wherein the homogenous composite granules have a bulk density of about 60-70 lbs/ft³.

9. The granular polymeric micronutrient composition of any one of embodiments 1-2 and 4-7, wherein the micronutrient component is selected from zinc (Zn), manganese (Mn), iron (Fe), copper (Cu), boron (B), and a combination thereof.

10. The granular polymeric micronutrient composition of any above embodiment, further comprising sulfur (S), wherein the sulfur, polyanionic polymer component and the micronutrient component are compressed into homogenous composite granules.

11. The granular polymeric micronutrient composition of any above embodiment, wherein the micronutrient component is released in a continuous manner in an amount ranging from about 50 to about 120 ppm over at least 24 hours.

12. The granular polymeric micronutrient composition of any above embodiment, wherein the micronutrient component is complexed with the polyanionic polymer component being at least 50 percent more chemically stable compared to a micronutrient component that is not complexed to the polyanionic polymer component.

13. The granular polymeric micronutrient composition of any above embodiment, wherein the micronutrient component is complexed with the polyanionic polymer component decreasing degradation of the micronutrient component by at least 50 percent compared to a micronutrient component that is not complexed to the polyanionic polymer component.

14. The granular polymeric micronutrient composition of any above embodiment, wherein the polyanionic polymer component comprises a maleic and an itaconic repeat unit.

15. The granular polymeric micronutrient composition of any above embodiment, wherein the polyanionic polymer component contains about 10 to about 90 mole percent of maleic repeat units and about 90 to about 10 mole percent itaconic repeat units.

16. The granular polymeric micronutrient composition of any above embodiment, wherein the polyanionic polymer component comprises an itaconic, a maleic, and a sulfonate repeat unit.

17. The granular polymeric micronutrient composition of any above embodiment, wherein the polyanionic polymer component comprises at least four repeat units distributed along the length of a polymer chain, said at least four repeat units including at least one each of type B repeat units, type C repeat units, and type G repeat units, wherein
a) the type B repeat units are independently selected from the group consisting of repeat units derived from substituted and unsubstituted monomers of maleic acid, maleic anhydride, fumaric acid, fumaric anhydride, mesaconic acid, mixtures of the foregoing, and any isomers, esters, acid chlorides, and partial or complete salts of any of the foregoing, wherein type B repeat units may be substituted with one or more C1-C6 straight or branched chain alkyl groups substantially free of ring structures and halo atoms, and wherein the salts have salt-forming cations selected from the group consisting of metals, amines, and mixtures thereof,
b) the type C repeat units selected from the group consisting of repeat units derived from substituted or unsubstituted monomers of itaconic acid, itaconic anhydride, and any isomers, esters, and the partial or complete salts of any of the foregoing, and mixtures of any of the foregoing, wherein the type C repeat units may be substituted with one or more C1-C6 straight or branched chain alkyl groups substantially free of ring structures and halo atoms, and wherein the salts have salt-forming cations selected from the group consisting of metals, amines, and mixtures thereof, and
c) the type G repeat units selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing, wherein type G repeat units may be substituted with one or more C1-C6 straight or branched chain alkyl groups substantially free of ring structures and halo atoms, and wherein the salts of the type G repeat units have salt-forming cations selected from the group consisting of metals, amines, and mixtures thereof.

18. The granular polymeric micronutrient composition of embodiment 17, wherein at least about 90 mole percent of the repeat units in the polyanionic polymer component is selected from the group consisting of type B, C, and G.

19. The granular polymeric micronutrient composition of embodiment 17 or 18, wherein the polyanionic polymer component comprises one type B repeat unit, one type C repeat unit, and one type G repeat unit.

20. The granular polymeric micronutrient composition of any one of embodiments 17-19, wherein the polyanionic polymer component has a repeat unit molar composition of:
1-70 mole percent type B repeat units, 1-80 mole percent type C repeat units, and 0.1-65 mole percent type G repeat units; or
20-65 mole percent type B repeat units, 15-75 mole percent type C repeat units, and 1-35 mole percent type G repeat units.

21. The granular polymeric micronutrient composition of embodiment 17, wherein the polyanionic polymer component comprises one type B repeat unit, one type C repeat unit, and two type G repeat units.

22. The granular polymeric micronutrient composition of embodiment 17 wherein the polyanionic polymer component comprises one maleic repeat unit, one itaconic repeat unit, and two type G repeat units respectively derived from methallylsulfonic acid and allylsulfonic acid.

23. The granular polymeric micronutrient composition of embodiment 17, wherein the polyanionic polymer component has a repeat unit molar composition of 35-55 mole percent type B repeat units, 20-55 mole percent type C repeat units, and 1-25 mole percent methallylsulfonic repeat units, and 1-20 mole percent allylsulfonic repeat units.

24. The granular polymeric micronutrient composition of embodiment 21, wherein the polyanionic polymer component has a repeat unit molar composition of
45 mole percent maleic repeat units, 50 mole percent itaconic repeat units, 4 mole percent methallylsulfonic repeat units, and 1 mole percent allylsulfonic repeat units; or
45 mole percent maleic repeat units, 35 mole percent itaconic repeat units, 15 mole percent methallylsulfonate repeat units, and 5 mole percent allylsulfonate repeat units.

25. The granular polymeric micronutrient composition of any above embodiment, wherein the polyanionic polymer component contains no more than about 10 mole percent of any of (i) non-carboxylate olefin repeat units, (ii) ether repeat units, and (iii) non-sulfonated monocarboxylic repeat units.

26. The granular polymeric micronutrient composition of any above embodiment, wherein the polyanionic polymer component has an average molecular weight of about 1,500-50,000 Da.

27. The granular polymeric micronutrient composition of any one of embodiments 17-26, wherein type B and type C repeat units contain a carboxylate group as an anionic functional group and type G repeat units contain a sulfonate group as an anionic functional group.

28. The granular polymeric micronutrient composition of any one of embodiments 17-27, wherein the polyanionic polymer component contains at least 90 mole percent repeat units containing an anionic functional group.

29. The granular polymeric micronutrient composition of any one of embodiments 17-28, wherein the micronutrient component is complexed with a fraction of the anionic functional groups present in the polyanionic polymer component, thereby forming a partial salt form of the polyanionic polymer component.

30. The granular polymeric micronutrient composition of any one of embodiments 17-29, wherein the micronutrient component is complexed with at least 50 percent of the anionic functional groups present in the polyanionic polymer component, thereby forming a partial salt form of the polyanionic polymer component.

31. The granular polymeric micronutrient composition of any one of embodiments 17-30, wherein the micronutrient component is complexed with all of the anionic functional groups present in the polyanionic polymer component, thereby forming a complete salt form of the polyanionic polymer component.

32. An agricultural composition comprising the granular polymeric micronutrient composition of any above embodiment and an agricultural product.

33. The agricultural composition of embodiment 33, wherein the agricultural product is a fertilizer.

34. The agricultural composition of embodiment 32 or 33, wherein the fertilizer is a solid.

35. The agricultural composition of any one of embodiments 32-34, wherein the fertilizer is an NPK fertilizer.

36. The agricultural composition of any one of embodiments 32-35, wherein the agricultural product and the granular polymeric micronutrient composition are present in a ratio of about 1:1 by weight.

37. A method of fertilizing soil and/or improving plant/crop growth and/or health comprising applying a granular polymeric micronutrient composition or an agricultural composition of any one of the embodiments to the soil.

38. The method of embodiment 37, wherein the granular polymeric micronutrient composition or agricultural composition is applied to the soil prior to emergence of a planted crop.

39. The method of embodiment 37 or 38, wherein the granular polymeric micronutrient composition or agricultural composition is applied to the soil adjacent to a plant, at the base of the plant, or in the root zone of the plant.

40. The method of any one of embodiments 37-39, wherein the plant/crop is selected from the group consisting of: cereal, wheat, barley, oat, triticale, rye, rice, maize, soya beans, potato, vegetable, peanuts, cotton, oilseed grape and fruit plant.

41. The method of any one of embodiments 37-40, wherein the applying step comprises contacting at a rate of about 5 lbs to about 30 lbs per acre of the granular polymeric micronutrient composition or agricultural composition.

42. The method of any one of embodiments 37-41, wherein the granular polymeric micronutrient composition is used in an amount ranging from about 25 to about 300 kg/ha.

### EXAMPLES

### Example 1: Synthesis of Class I Polymers

The following examples describe preferred synthesis techniques for preparing polymers; it should be understood, however, that these examples are provided by way of illustration only and nothing therein should be taken as a limitation on the overall scope of the invention. It will further be understood that the following examples relate to synthesis of the starting polymers, which are then complexed with micronutrients (e.g., Zn, Mn, and Cu) to produce partial or combined salts which are to be used in the disclosed granular polymeric micronutrient composition.

### Example 1.1—Exemplary Synthesis

Apparatus: A cylindrical reactor was used, capable of being heated and cooled, and equipped with efficient mechanical stirrer, condenser, gas outlet (open to atmosphere), solids charging port, liquids charging port, thermometer and peroxide feeding tube.

Procedure: Water was charged into the reactor, stirring was initiated along with heating to a target temperature of 95° C. During this phase, itaconic acid, sodium methallylsulfonate, sodium allylsulfonate, and maleic anhydride were added so as to make a 50% w/w solids dispersion with the following monomer mole fractions:
maleic: 45%
itaconic: 35%
methallylsulfonate: 15%
allylsulfonate: 5%

When the reactor temperature reached 95° C., vanadium oxysulfate was added to give a vanadium metal concentration of 25 ppm by weight. After the vanadium salt fully dissolved, hydrogen peroxide (as 50% w/w dispersion) was added continuously over three hours, using the feeding tube. The total amount of hydrogen peroxide added was 5% of the dispersion weight in the reactor prior to peroxide addition. After the peroxide addition was complete, the reactor was held at 95° C. for two hours, followed by cooling to room temperature.

The resulting polymer dispersion was found to have less than 2% w/w total of residual monomers as determined by chromatographic analysis.

### Example 1.2—Exemplary Synthesis

Apparatus: Same as Example 1.

Procedure: Water was charged into the reactor, stirring was initiated along with heating to a target temperature of 100° C. During this phase, itaconic acid, sodium methallylsulfonate, sodium allylsulfonate, and maleic anhydride were added so as to make a 70% w/w solids dispersion with the following monomer mole fractions:
maleic: 45%
itaconic: 50%
methallylsulfonate: 4%
allylsulfonate: 1%

When the reactor temperature reached 100° C., vanadium oxysulfate was added to give a vanadium metal concentration of 25 ppm by weight. After the vanadium salt fully dissolved, hydrogen peroxide (as 50% w/w dispersion) was added continuously over three hours, using the feeding tube. The total amount of hydrogen peroxide added was 7.5% of the dispersion weight in the reactor prior to peroxide addition. After the peroxide addition was complete, the reactor was held at 100° C. for two hours, followed by cooling to room temperature.

The resulting polymer dispersion was found to have less than 1% w/w total of residual monomers as determined by chromatographic analysis.

### Example 1.3—Preparation of Tetrapolymer Partial Salts

A tetrapolymer calcium sodium salt dispersion containing 40% by weight polymer solids in water was prepared by the preferred free radical polymerization synthesis, using an aqueous monomer reaction mixture having 45 mole percent maleic anhydride, 35 mole percent itaconic acid, 15 mole percent methallylsulfonate sodium salt, and 5 mole percent allylsulfonate. The final tetrapolymer dispersion had a pH of slightly below 1.0 and was a partial sodium salt owing to the sodium cation on the sulfonate monomers. At least about 90% of the monomers were polymerized in the reaction.

The resultant polymer is then conventionally reacted with appropriate micronutrient sources (e.g., Zn, Mn, and Cu) in order to create a final partial salt polymer having the desired pH and metal contents for the disclosed granular polymeric micronutrient composition.

### Example 1.4—Exemplary Synthesis

A terpolymer salt dispersion containing 70% by weight polymer solids in water was prepared using a cylindrical reactor capable of being heated and cooled, and equipped with an efficient mechanical stirrer, a condenser, a gas outlet open to the atmosphere, respective ports for charging liquids and solids to the reactor, a thermometer, and a peroxide feeding tube.

Water (300 g) was charged into the reactor with stirring and heating to a target temperature of 95° C. During heating, itaconic acid, sodium methallylsulfonate, and maleic anhydride were added so as to make a 75% w/w solids dispersion with the following monomer mole fractions: maleic anhydride—20%; itaconic acid—60%; methallylsulfonate sodium salt—20%. When the monomers were initially added, they were in suspension in the water. As the temperature rose, the monomers became more fully dissolved before polymerization was initiated, and the maleic anhydride was hydrolyzed to maleic acid. When the reactor temperature reached 95° C., vanadium oxysulfate was added to yield a vanadium metal concentration of 50 ppm by weight of the reactor contents at the time of addition of the vanadium salt. After the vanadium salt fully dissolved, hydrogen peroxide was added as a 50% w/w dispersion in water continuously over two hours. At the time of hydrogen peroxide addition, not all of the monomers were completely dissolved, achieving what is sometimes referred to as “slush polymerization”; the initially undissolved monomers were subsequently dissolved during the course of the reaction. The total amount of hydrogen peroxide added equaled 5% of the dispersion weight in the reactor before addition of the peroxide.

After the peroxide addition was completed, the reaction mixture was held at 95° C. for two hours, and then allowed to cool to room temperature. The resulting polymer dispersion had a pH of slightly below 1.0 and was a partial sodium salt owing to the sodium cation on the sulfonate monomers. The dispersion was found to have a monomer content of less than 2% w/w, calculated as a fraction of the total solids in the reaction mixture, as determined by chromatographic analysis. Accordingly, over 98% w/w of the initially added monomers were converted to polymer.

This polymer is then conventionally reacted with micronutrients in their salt and/or sucrate form (e.g., Zn, Mn, and Cu salts/sucrates) in order to yield the partial salt polymers, at the appropriate pH levels.

### Example 2: Examination of the Dissolution Rate of Various Zinc Sources

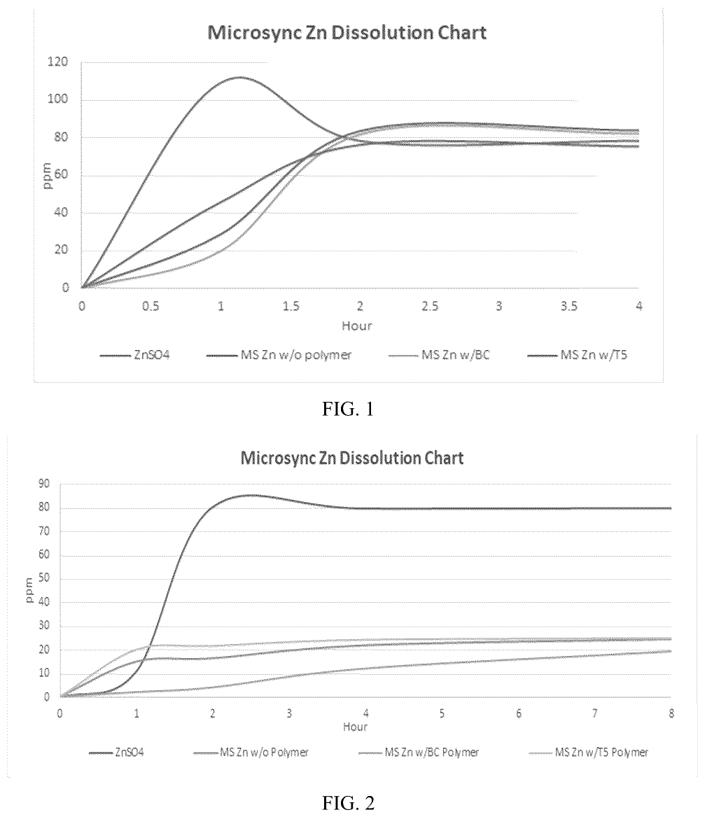

A series of samples containing Zn derived from various sources were evaluated for their Zn dissolution properties by following the protocol outlined below:
1. The samples were each prepared to contain 80 ppm Zn in DI water. The solutions were shaken at 80 rpm at 25° C. for 24 hrs.
2. After 0, 1, 2, 4, 8, 24 hrs of being shaken, a portion of each solution was removed from the sample for testing and filtered prior to Zn analysis. The amount of sample removed from each solution was replaced with the same amount of DI water, which was added back to each solution.
3. Zn analysis of the dissolution samples was carried out by Inductively Coupled Plasma Mass Spectroscopy (ICP-OES) to determine the Zn content. The dissolved Zn at each time point in each solution was calculated and the dissolution curves are shown in Table 1 and in FIG. 1.

TABLE 1

| Time | Zn Dissolved (ppm) | | | |
|---|---|---|---|---|
| (Hr) | ZnSO4* | MS Zn w/o polymer | MS Zn w/BC | MS Zn w/T5 |
| 0 | 0 | 0 | 0 | 0 |
| 1 | 109 | 29 | 20 | 46 |
| 2 | 78 | 84 | 82 | 76 |
| 4 | 78 | 84 | 82 | 75 |
| 8 | 78 | 85 | 82 | 76 |
| 24 | 78 | 88 | 83 | 79 |

ZnSO4*: “Hi-Yield Zinc Sulfate” from Voluntary Purchasing Groups, Inc.

### Example 3: Examination of the Dissolution Rate of Various Zinc Sources

A series of granular samples containing Zn derived from various sources were evaluated for their Zn dissolution properties by following the protocol outlined below:
1. The testing solutions were prepared immediately before the testing and each contained 80 ppm Zn in DI water. The solutions were shaken at 50 rpm at 25° C. and the granules in the solutions were gradually dissipated and/or dissolved to release Zn to the solutions over time.
2. At the 0, 1, 2, 4, 8 hrs of being shaken, a portion of each solution was removed from the sample and filtered for Zn analysis. The amount removed from each solution was replaced by adding the same amount of DI water back into the solution. The solutions were, then, shaken again until the next sampling time.
3. Zn analysis of the dissolution samples was carried out by Inductively Coupled Plasma Mass Spectroscopy (ICP-OES) to determine the Zn content. The dissolved Zn at each time point in each solution was calculated and the dissolution curves are shown in Table 2 and in FIG. 2.

TABLE 2

| Time | Zn Dissolved (ppm) | | | |
|---|---|---|---|---|
| (Hr) | ZnSO4* | MS Zn w/o polymer | MS Zn w/BC | MS Zn w/T5 |
| 0 | 0 | 0 | 0 | 0 |
| 1 | 11 | 15 | 2 | 20 |
| 2 | 80 | 16 | 4 | 22 |
| 4 | 80 | 22 | 12 | 24 |
| 8 | 80 | 25 | 20 | 25 |

Of note is that the main difference between the two experiments is the shaking speed of the testing solutions. In the second experiment, the speed was optimized to better demonstrate the difference of dissolution patterns of the samples.

That which is claimed is:

1. A granular polymeric micronutrient composition comprising:
a polyanionic polymer component; and
a micronutrient component selected from zinc (Zn), manganese (Mn), iron (Fe), copper (Cu), boron (B), and a combination thereof,
wherein the polyanionic polymer component and the micronutrient component are compressed into homogenous composite granules having a mesh size ranging from about 6 to about 100 US mesh.

2. The granular polymeric micronutrient composition of claim 1, wherein the homogenous composite granules have a mesh size ranging from about 6 to about 16 US mesh.

3. The granular polymeric micronutrient composition of claim 1, wherein the homogenous composite granules have a mean particle size (d50) ranging from about 0.5 to about 2.5 mm.

4. The granular polymeric micronutrient composition of claim 1, wherein the homogenous composite granules have a particle size ranging from about 90 to about 230 SGN.

5. The granular polymeric micronutrient composition of claim 1, wherein the homogenous composite granules have a uniformity index ranging between 35-45.

6. The granular polymeric micronutrient composition of claim 1, wherein the homogenous composite granules have a bulk density of about 60-70 lbs/ft³.

7. The granular polymeric micronutrient composition of claim 1, further comprising sulfur (S), wherein the sulfur, polyanionic polymer component and the micronutrient component are compressed into homogenous composite granules.

8. The granular polymeric micronutrient composition of claim 1, wherein the micronutrient component is released in a continuous manner in an amount ranging from about 50 to about 120 ppm over at least 24 hours.

9. The granular polymeric micronutrient composition of claim 1, wherein the micronutrient component is complexed with the polyanionic polymer component being at least 50 percent more chemically stable compared to a micronutrient component that is not complexed to the polyanionic polymer component.

10. The granular polymeric micronutrient composition of claim 1, wherein the micronutrient component is complexed with the polyanionic polymer component decreasing degradation of the micronutrient component by at least 50 percent compared to a micronutrient component that is not complexed to the polyanionic polymer component.

11. The granular polymeric micronutrient composition of claim 1, wherein the polyanionic polymer component comprises a maleic and an itaconic repeat unit.

12. The granular polymeric micronutrient composition of claim 11, wherein the polyanionic polymer component contains about 10 to about 90 mole percent of maleic repeat units and about 90 to about 10 mole percent itaconic repeat units.

13. The granular polymeric micronutrient composition of claim 1, wherein the polyanionic polymer component comprises an itaconic, a maleic, and a sulfonate repeat unit.

14. The granular polymeric micronutrient composition of claim 1, wherein the polyanionic polymer component comprises at least four repeat units distributed along the length of a polymer chain, said at least four repeat units including at least one each of type B repeat units, type C repeat units, and type G repeat units, wherein
a) the type B repeat units are independently selected from the group consisting of repeat units derived from substituted and unsubstituted monomers of maleic acid, maleic anhydride, fumaric acid, fumaric anhydride, mesaconic acid, mixtures of the foregoing, and any isomers, esters, acid chlorides, and partial or complete salts of any of the foregoing, wherein type B repeat units may be substituted with one or more C1-C6 straight or branched chain alkyl groups substantially free of ring structures and halo atoms, and wherein the salts have salt-forming cations selected from the group consisting of metals, amines, and mixtures thereof,
b) the type C repeat units selected from the group consisting of repeat units derived from substituted or unsubstituted monomers of itaconic acid, itaconic anhydride, and any isomers, esters, and the partial or complete salts of any of the foregoing, and mixtures of any of the foregoing, wherein the type C repeat units may be substituted with one or more C1-C6 straight or branched chain alkyl groups substantially free of ring structures and halo atoms, and wherein the salts have salt-forming cations selected from the group consisting of metals, amines, and mixtures thereof, and
c) the type G repeat units selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing, wherein type G repeat units may be substituted with one or more C1-C6 straight or branched chain alkyl groups substantially free of ring structures and halo atoms, and wherein the salts of the type G repeat units have salt-forming cations selected from the group consisting of metals, amines, and mixtures thereof.

15. The granular polymeric micronutrient composition of claim 14, wherein at least about 90 mole percent of the repeat units in the polyanionic polymer component is selected from the group consisting of type B, C, and G.

16. The granular polymeric micronutrient composition of claim 14, wherein the polyanionic polymer component comprises one type B repeat unit, one type C repeat unit, and one type G repeat unit.

17. The granular polymeric micronutrient composition of claim 16, wherein the polyanionic polymer component has a repeat unit molar composition of:
1-70 mole percent type B repeat units, 1-80 mole percent type C repeat units, and 0.1-65 mole percent type G repeat units; or
20-65 mole percent type B repeat units, 15-75 mole percent type C repeat units, and 1-35 mole percent type G repeat units.

18. The granular polymeric micronutrient composition of claim 14, wherein the polyanionic polymer component comprises one type B repeat unit, one type C repeat unit, and two type G repeat units.

19. The granular polymeric micronutrient composition of claim 18 wherein the polyanionic polymer component comprises one maleic repeat unit, one itaconic repeat unit, and two type G repeat units respectively derived from methallylsulfonic acid and allylsulfonic acid.

20. The granular polymeric micronutrient composition of claim 18, wherein the polyanionic polymer component has a repeat unit molar composition of 35-55 mole percent type B repeat units, 20-55 mole percent type C repeat units, and 1-25 mole percent methallylsulfonic repeat units, and 1-20 mole percent allylsulfonic repeat units.

21. The granular polymeric micronutrient composition of claim 20, wherein the polyanionic polymer component has a repeat unit molar composition of
45 mole percent maleic repeat units, 50 mole percent itaconic repeat units, 4 mole percent methallylsulfonic repeat units, and 1 mole percent allylsulfonic repeat units; or
45 mole percent maleic repeat units, 35 mole percent itaconic repeat units, 15 mole percent methallylsulfonate repeat units, and 5 mole percent allylsulfonate repeat units.

22. The granular polymeric micronutrient composition of claim 1, wherein the polyanionic polymer component contains no more than about 10 mole percent of any of (i) non-carboxylate olefin repeat units, (ii) ether repeat units, and (iii) non-sulfonated monocarboxylic repeat units.

23. The granular polymeric micronutrient composition of claim 1, wherein the polyanionic polymer component has an average molecular weight of about 1,500-50,000 Da.

24. The granular polymeric micronutrient composition of claim 14, wherein type B and type C repeat units contain a carboxylate group as an anionic functional group and type G repeat units contain a sulfonate group as an anionic functional group.

25. The granular polymeric micronutrient composition of claim 24, wherein the polyanionic polymer component contains at least 90 mole percent repeat units containing an anionic functional group.

26. The granular polymeric micronutrient composition of claim 25, wherein the micronutrient component is complexed with a fraction of the anionic functional groups present in the polyanionic polymer component, thereby forming a partial salt form of the polyanionic polymer component.

27. The granular polymeric micronutrient composition of claim 26, wherein the micronutrient component is complexed with at least 50 percent of the anionic functional groups present in the polyanionic polymer component, thereby forming a partial salt form of the polyanionic polymer component.

28. The granular polymeric micronutrient composition of claim 26, wherein the micronutrient component is complexed with all of the anionic functional groups present in the polyanionic polymer component, thereby forming a complete salt form of the polyanionic polymer component.

29. An agricultural composition comprising the granular polymeric micronutrient composition of claim 1 and an agricultural product.

30. The agricultural composition of claim 29, wherein the agricultural product is a fertilizer.

31. The agricultural composition of claim 30, wherein the fertilizer is a solid.

32. The agricultural composition of claim 30, wherein the fertilizer is an NPK fertilizer.

33. The agricultural composition of claim 29, wherein the agricultural product and the granular polymeric micronutrient composition are present in a ratio of about 1:1 by weight.

34. A method of improving plant growth and/or health comprising applying a granular polymeric micronutrient composition of claim 1 to the soil.

35. The method of claim 34, wherein the granular polymeric micronutrient composition is applied to the soil prior to emergence of a crop plant.

36. The method of claim 34, wherein the granular polymeric micronutrient composition is applied to the soil adjacent to a crop plant, at the base of the crop plant, or in the root zone of the crop plant.

37. The method of claim 34, wherein the crop plant is selected from the group consisting of: cereal, wheat, barley, oat, triticale, rye, rice, maize, soya beans, potato, vegetable, peanuts, cotton, oilseed grape and fruit plant.

38. The method of claim 34, wherein the applying step comprises contacting at a rate of about 5 lbs to about 30 lbs per acre of the granular polymeric micronutrient composition.

39. The method of claim 34, wherein the granular polymeric micronutrient composition is used in an amount ranging from about 25 to about 300 kg/ha.
